(19) United States
(12) Patent Application Publication
(10) Pub. No.: US 2026/0058540 A1
(43) Pub. Date: Feb. 26, 2026

(54) METHODS AND APPARATUS TO IMPROVE CONVERTER CIRCUITRY USING PHASE ANGLE CONTROL WITH FREQUENCY TRACKING

(71) Applicant: Texas Instruments Incorporated, Dallas, TX (US)

(72) Inventors: Michael Lueders, Freising (DE); Suvadip Banerjee, Bangalore (IN); Ashutosh Pathy, Bengaluru (IN)

(21) Appl. No.: 18/905,807

(22) Filed: Oct. 3, 2024

(30) Foreign Application Priority Data
Aug. 21, 2024 (IN) 202441064228

(51) Int. Cl. H02M 1/08; H02M 1/00; H02M 1/32; H02M 1/36; H02M 7/217

(52) U.S. Cl. CPC H02M 1/083; H02M 1/007; H02M 1/32; H02M 1/36; H02M 7/217

(57) ABSTRACT

An example apparatus includes: an AC supply terminal; first current source circuitry having a first terminal, a second terminal, and a control terminal; second current source circuitry having a first terminal and a control terminal, the first terminal of the second current source circuitry coupled to the AC supply terminal and the first terminal of the first current source circuitry; a capacitor having a terminal; comparator circuitry having an input terminal and an output terminal, the input terminal of the comparator circuitry coupled to the terminal of the capacitor and the second terminal of the first current source circuitry; and timer circuitry having an input terminal, a first output terminal, and a second output terminal, the input terminal of the timer circuitry coupled to the output terminal of the comparator circuitry, the first output terminal of the timer circuitry coupled to the control terminal of the first current source circuitry.

### CROSS-REFERENCE TO RELATED APPLICATION

This patent application claims the benefit of and priority to Indian Provisional Patent Application No. 202441064228 filed Aug. 21, 2024, which is hereby incorporated herein by reference in its entirety.

### TECHNICAL FIELD

This description relates generally to converter circuitry and, more particularly, to methods and apparatus to improve converter circuitry using phase angle control with frequency tracking.

### BACKGROUND

Alternating current (AC) to direct current (DC) converter circuitry generates a DC output using power from an AC power supply. Phase angle control (PAC) allows AC to DC converters to draw current from the AC power supply as the voltage of the AC supply is near a zero-crossing. Such operations allow the AC to DC converter circuitry to efficiently generate the DC output using current from an AC power supply.

### SUMMARY

For methods and apparatus to improve converter circuitry using phase angle control with frequency tracking, an example apparatus includes an alternating current (AC) supply terminal; first current source circuitry having a first terminal, a second terminal, and a control terminal; second current source circuitry having a first terminal and a control terminal, the first terminal of the second current source circuitry coupled to the AC supply terminal and the first terminal of the first current source circuitry; a capacitor having a terminal; comparator circuitry having an input terminal and an output terminal, the input terminal of the comparator circuitry coupled to the terminal of the capacitor and the second terminal of the second current source circuitry; and timer circuitry having an input terminal, a first output terminal, and a second output terminal, the input terminal of the timer circuitry coupled to the output terminal of the comparator circuitry, the first output terminal of the timer circuitry coupled to the control terminal of the first current source circuitry, the second output terminal of the timer circuitry coupled to the control terminal of the second current source circuitry. Other examples are described.

For methods and apparatus to improve converter circuitry using phase angle control with frequency tracking, an example apparatus includes a supply terminal configured to receive a rectified signal; first current source circuitry coupled to the supply terminal, the first current source circuitry configured to discharge the supply terminal responsive to a first voltage; second current source circuitry coupled to the supply terminal and the first current source circuitry, the second current source circuitry configured to supply a current from the supply terminal responsive to a second voltage; a capacitor coupled to the second current source circuitry, the capacitor configured to generate a direct current (DC) supply voltage responsive to current from the second current source circuitry; and frequency lock circuitry coupled to the supply terminal, the first current source circuitry, and the second current source circuitry. the frequency lock circuitry configured to: predict a zero-crossing of the rectified signal; generate the first voltage before the predicted zero-crossing; and detect a zero-crossing of the rectified signal after generating the first voltage; and generate the second voltage after detecting the zero-crossing. Other examples are described.

For methods and apparatus to improve converter circuitry using phase angle control with frequency tracking, an example power supply includes a supply terminal configured to receive a rectified signal; first current source circuitry coupled to the supply terminal, the first current source circuitry configured to discharge the supply terminal; second current source circuitry coupled to the supply terminal and the first current source circuitry, the second current source circuitry configured to supply a current from the supply terminal; a capacitor coupled to the second current source circuitry, the capacitor configured to generate a direct current (DC) supply voltage responsive to current from the second current source circuitry; and comparator circuitry coupled to the supply terminal, the comparator circuitry configured to determine zero-crossings of the rectified signal; and timer circuitry coupled to the first current source circuitry, the second current source circuitry, and the comparator circuitry, the timer circuitry configured to: determine a first duration between a first zero-crossing and a second zero-crossing of the rectified signal; determine a second duration between the second zero-crossing and a third zero-crossing of the rectified signal; predict subsequent zero-crossings of the rectified signal based on the first duration and the second duration; and control the first current source circuitry and the second current source circuitry based on the subsequent zero-crossings. Other examples are described.

### BRIEF DESCRIPTION OF THE DRAWINGS

FIG. 1 is a block diagram of example AC to DC converter circuitry including example PAC converter circuitry and example frequency lock circuitry.

FIG. 2 is a schematic diagram of an example of the PAC converter circuitry of FIG. 1.

FIGS. 3A, 3B, and 3C form a schematic diagram of an example of the AC to DC converter circuitry of FIG. 1 including another example of the PAC converter circuitry of FIGS. 1 and 2 and the frequency lock circuitry of FIG. 1 further having example frequency tracking circuitry.

FIG. 4 is a block diagram of an example of the frequency tracking circuitry of FIG. 3A.

FIG. 5 is a flowchart representative of example machine-readable instructions or example operations that may be at least one of executed, instantiated, or performed using example implementations of the PAC converter circuitry of FIGS. 1, 2, 3A, 3B, and 3C, the frequency lock circuitry of FIGS. 1 and 3A, or more generally the AC to DC converter circuitry of FIGS. 1, 3A, 3B, and 3C.

FIG. 6 is a flowchart representative of example machine-readable instructions or example operations that may be at least one of executed, instantiated, or performed using an example implementation of the frequency tracking circuitry of FIGS. 3A and 4, or more generally the AC to DC converter circuitry of FIGS. 1, 3A, 3B, and 3C.

FIG. 7 is a timing diagram of example operations of the PAC converter circuitry of FIGS. 1, 2, 3A, 3B, and 3C, the frequency lock circuitry of FIGS. 1, 3A, 3B, and 3C, or more generally the AC to DC converter circuitry of FIGS. 1, 3A, 3B, and 3C.

FIG. 8 is a block diagram of an example processing platform including programmable circuitry structured to execute, instantiate, or perform the example machine-readable instructions or perform the example operations of FIGS. 5 and 6 to implement the frequency tracking circuitry of FIGS. 3A and 4.

FIG. 9 is a block diagram of an example implementation of the programmable circuitry of FIG. 8.

FIG. 10 is a block diagram of another example implementation of the programmable circuitry of FIG. 8.

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

Alternating current (AC) to direct current (DC) converter circuitry generates a DC output using power from an AC power supply. Phase angle control allows AC to DC converters to draw current from the AC power supply as the voltage of the AC supply is approaching a zero-crossing. Such operations allow the AC to DC converter circuitry to efficiently generate the DC output using current from an AC power supply.

AC to DC converter circuitry converts an AC signal from an AC power supply to a DC supply voltage to supply power to devices that operate using a DC supply voltage. A common AC power supply is referred to as the grid, which supplies a line signal and a neutral connection via a grid connection (e.g., outlet). The line signal is a sinusoidal AC signal having a frequency that is fifty or sixty hertz (Hz), but that frequency may be based on geographical location. The neutral connection is reference potential (e.g., ground). In some regions, such as North America, the amplitude of the line signal is sinusoidal having a maximum voltage of one-hundred and twenty volts with respect to the neutral connection and a minimum voltage of negative one-hundred and twenty volts with respect to the neutral connection. In some such instances, the AC to DC converter circuitry needs to step down the voltage of the line signal to generate a relatively lower voltage DC supply.

Some AC to DC converter circuitry includes rectifier circuitry, first current source circuitry, second current source circuitry, a capacitor, and a diode. The rectifier circuitry generates a rectified high voltage signal responsive to receiving the line signal and the neutral connection. The first current source circuitry sinks a current from the rectified high voltage signal to drive the rectified high voltage signal to the common potential, which is referred to as a zero-crossing. The second current source circuitry supplies a current to the capacitor. The capacitor generates a first DC supply voltage responsive to the current from the second current source. The voltage drop across the diode produces a second DC supply voltage. The diode also reduces the likelihood of current from circuitry coupled to the second DC supply voltage from charging the capacitor. However, continuously sinking using the first current source circuitry to drive the rectified high voltage signal to a zero-crossing increases power consumption. Also, continuously supplying current to the capacitor across all voltages of the line signal results in having to size the components of the AC to DC converter circuitry to safely operate at all voltages of the rectified high voltage signal. In such examples, increasing the size of components, such as the capacitor, increases the system-on-chip size of the AC to DC converter circuitry.

Some AC to DC converter circuitry implements phase angle control (PAC) to regulate the supply of current to the capacitor. Such AC to DC converter circuitry includes circuitry to detect when the rectified high voltage signal is approaching a zero-crossing. The first current source circuitry allows the AC to DC converter circuitry to detect when the rectified high voltage signal is at a zero-crossing. The AC to DC converter circuitry determines a new phase of the rectified high voltage signal begins responsive to detecting the zero-crossing. The AC to DC converter circuitry uses the second current source circuitry to charge the capacitor during the duration of time between the detected zero-crossing and detecting the rectified high voltage signal is greater than a reference voltage. Such a process of turning on and off the second current source circuitry is referred to as PAC. In such examples, components of the AC to DC converter circuitry are sized to support voltages as high as the reference voltage. However, using the first current source circuitry to detect a zero-crossing of the rectified high voltage signal by continuously sinking a current increases the power consumption of the AC to DC converter circuitry.

Examples described herein include methods and apparatus to improve converter circuitry using phase angle control with frequency tracking. In some described examples, AC to DC converter circuitry includes PAC converter circuitry and frequency lock circuitry. The example PAC converter circuitry described herein includes rectifier circuitry, first current source circuitry, second current source circuitry, a capacitor, and a diode. The rectifier circuitry rectifies the line signal to produce a rectified signal. The first current source circuitry drives the rectified signal to a zero-crossing. The second current source circuitry charges the capacitor by supplying current from the rectified signal. The capacitor generates a first DC supply voltage responsive to current from the second current source circuitry. The diode produces a second DC supply voltage responsive to the first DC supply voltage and the voltage drop across the diode. The example frequency lock circuitry includes first comparator circuitry, second comparator circuitry, and frequency tracking circuitry. The first comparator circuitry compares the rectified signal to a reference zero-crossing voltage to detect zero-crossings. The second comparator circuitry compares the first DC supply voltage to a reference voltage to detect when the capacitor is charged. The frequency tracking circuitry controls the first and second current source circuitry responsive to the outputs of the first comparator circuitry and the second comparator circuitry.

In example operations, the frequency tracking circuitry determines a reference even duration and a reference odd duration to characterize timing of the rectified signal. The reference odd duration is a value representing the duration between a first zero-crossing and a second zero-crossing. The second zero-crossing is the zero-crossing immediately succeeding the first zero-crossing. The reference even duration is a value representing the duration between the second zero-crossing and a third zero-crossing. The third zero-crossing is the zero-crossing immediately succeeding the second zero-crossing. Advantageously, the rectifier circuitry produces the rectified signal based on a sinusoidal signal, which is cyclical. The frequency tracking circuitry represents the rectified signal as a repeating sequence of reference even and odd durations.

In some such example operations, the frequency tracking circuitry predicts subsequent zero-crossings of the rectified signal responsive to the detection of a zero-crossing and one of the reference even or odd durations. The frequency tracking circuitry turns on the first current source circuitry prior to a predicted zero-crossing to drive the rectified signal to a zero-crossing. The frequency tracking circuitry turns off the first current source circuitry responsive to detecting the zero-crossing and turns on the second current source circuitry to charge the capacitor. The frequency tracking circuitry turns off the second current source circuitry responsive to a determination that the first DC supply voltage is at a reference voltage or the rectified signal is greater than a maximum safe voltage. Advantageously, the frequency tracking circuitry adaptively turns on the first current source circuitry prior to a predicted zero-crossing based on the reference even and odd durations. Advantageously, decreasing the duration of time that the first current source circuitry sinks current from the rectified signal increases power efficiency.

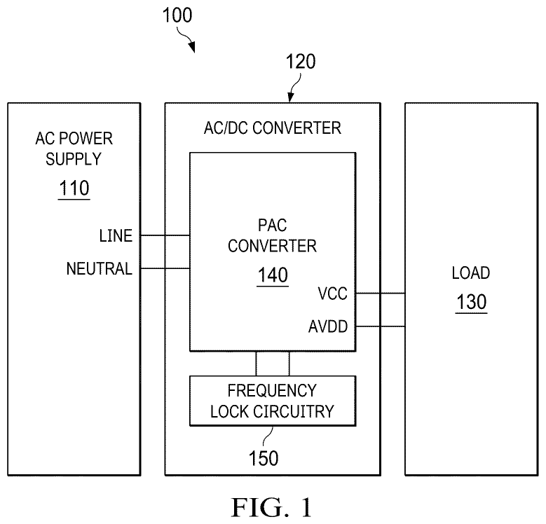

FIG. 1 is a block diagram of an example power supply system 100. In the example of FIG. 1, the power supply system 100 includes an AC power supply 110, AC to DC converter circuitry 120, and a load 130. The example AC to DC converter circuitry 120 of FIG. 1 includes example PAC converter circuitry 140 and example frequency lock circuitry 150. In some examples, one or more components of the power supply system 100 are included in different packages, at different locations, or integrated into one or more packages. For example, when the power supply system 100 represents a laptop charging system, the AC power supply 110 may be referred to as an outlet, the AC to DC converter circuitry 120 may be referred to as a charger, and the load 130 may be referred to as the laptop. In other examples, the power supply system 100 may represent any type of system structured to produce a DC supply voltage from an AC supply voltage.

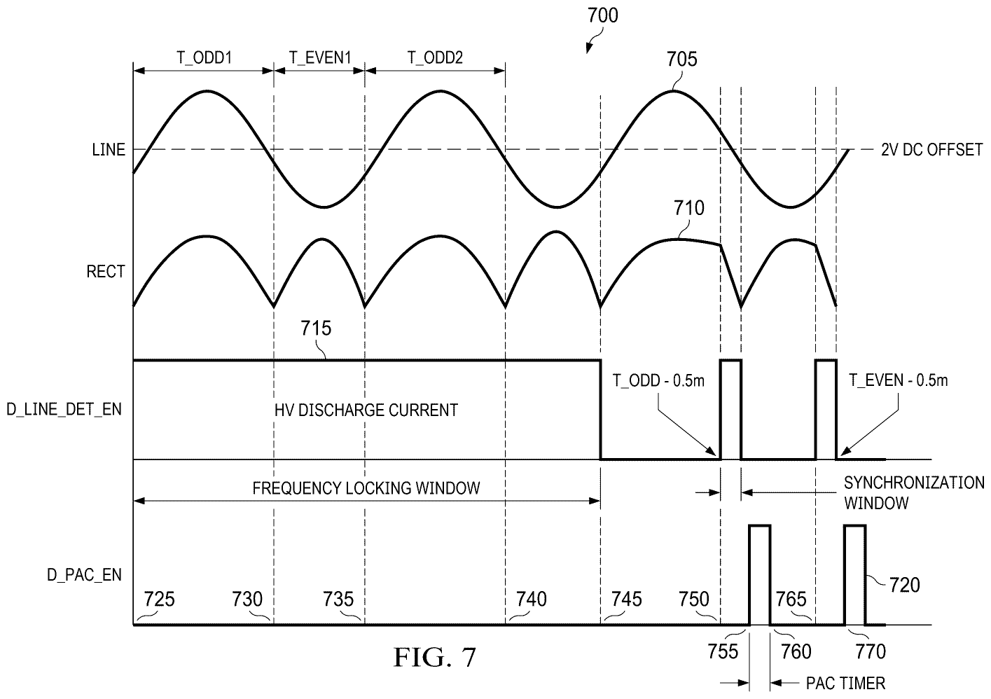

The AC power supply 110 has a first terminal and a second terminal. The first terminal of the AC power supply 110 (also referred to as a line output, or line terminal) is coupled to the AC to DC converter circuitry 120. The second terminal of the AC power supply 110 (also referred to as a neutral output or neutral terminal) is coupled to the AC to DC converter circuitry 120. In some examples, the AC power supply 110 is illustrated or referred to as a grid connection, which represents a connection of the AC to DC converter circuitry 120 to the electrical grid. For example, the AC power supply 110 is an illustrative representation of power delivery infrastructure often referred to as the grid. In some such examples, the line terminal of the AC power supply 110 supplies an AC signal and the neutral terminal of the AC power supply 110 supplies a reference potential (e.g., common potential, ground, etc.). An example of the AC signal from the AC power supply 110 is illustrated and described in connection with FIG. 7, below.

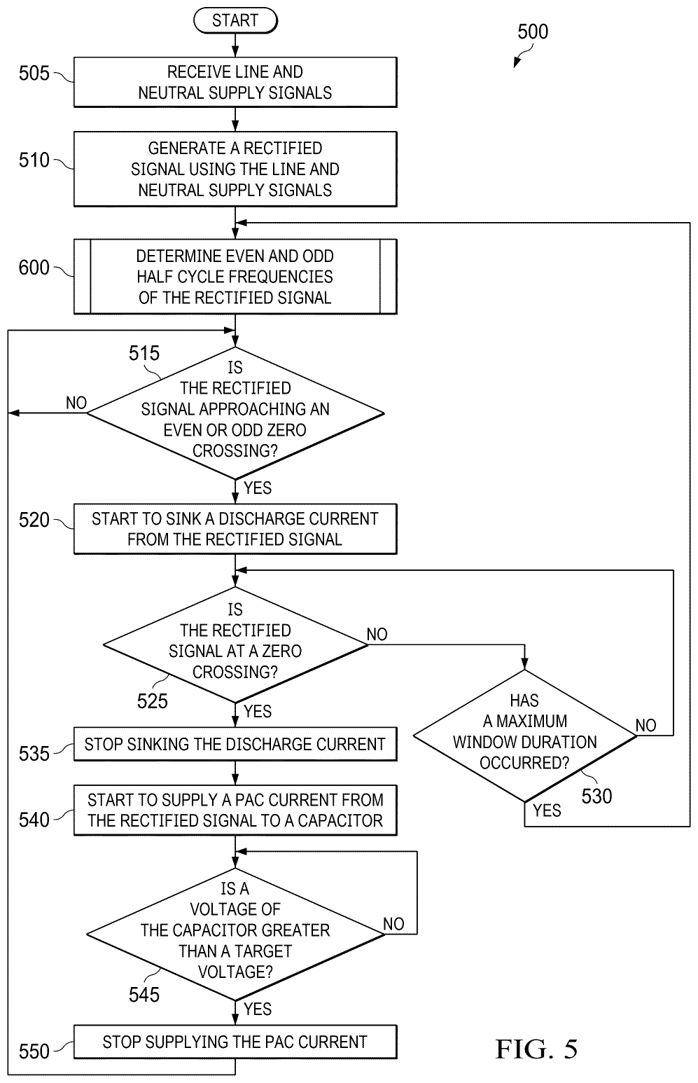

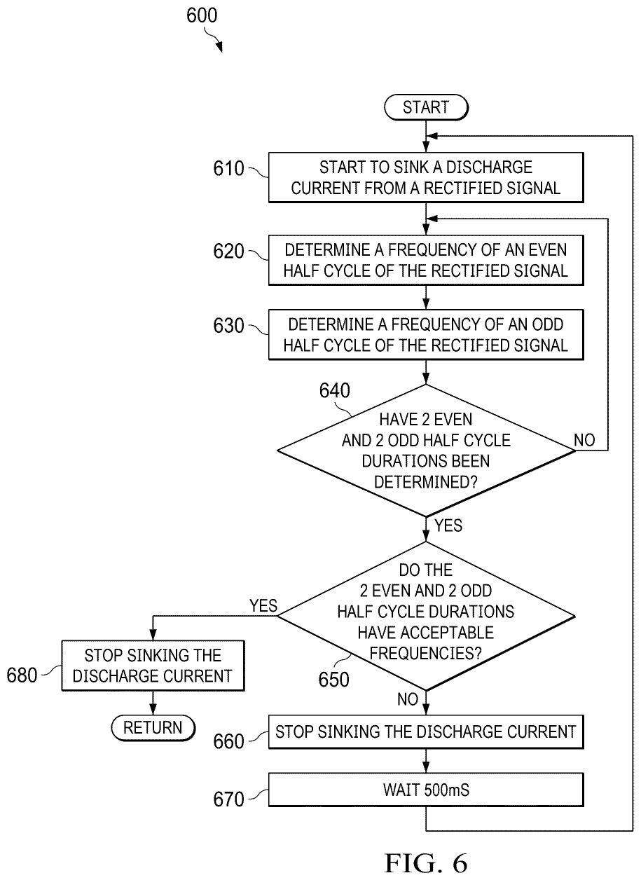

The AC to DC converter circuitry 120 has a first terminal, a second terminal, a third terminal, and a fourth terminal. The first and second terminals of the AC to DC converter circuitry 120 are coupled to the AC power supply 110. In some examples, the first terminal of the AC to DC converter circuitry 120 is referred to as an AC supply terminal. The third terminal of the AC to DC converter circuitry 120 (also referred to as a first output terminal) is coupled to the load 130. The fourth terminal of the AC to DC converter circuitry 120 (also referred to as a second output terminal) is coupled to the load 130. In the example of FIG. 1, the AC to DC converter circuitry 120 supplies a first supply voltage (VCC) and a second supply voltage (AVDD) to the load 130 responsive to current from the AC power supply 110. The first supply voltage is a DC supply voltage and the second supply voltage is a DC supply voltage, which is based on the first supply voltage. Example operations of the AC to DC converter circuitry 120 are illustrated and described in connection with FIGS. 5 and 6, below.

The load 130 as a first terminal and a second terminal coupled to the AC to DC converter circuitry 120. In the example of FIG. 1, the load 130 is structured to receive the first and second supply voltages from the AC to DC converter circuitry 120. In other examples, the load 130 may only receive one of the first or second supply voltages from the AC to DC converter circuitry 120.

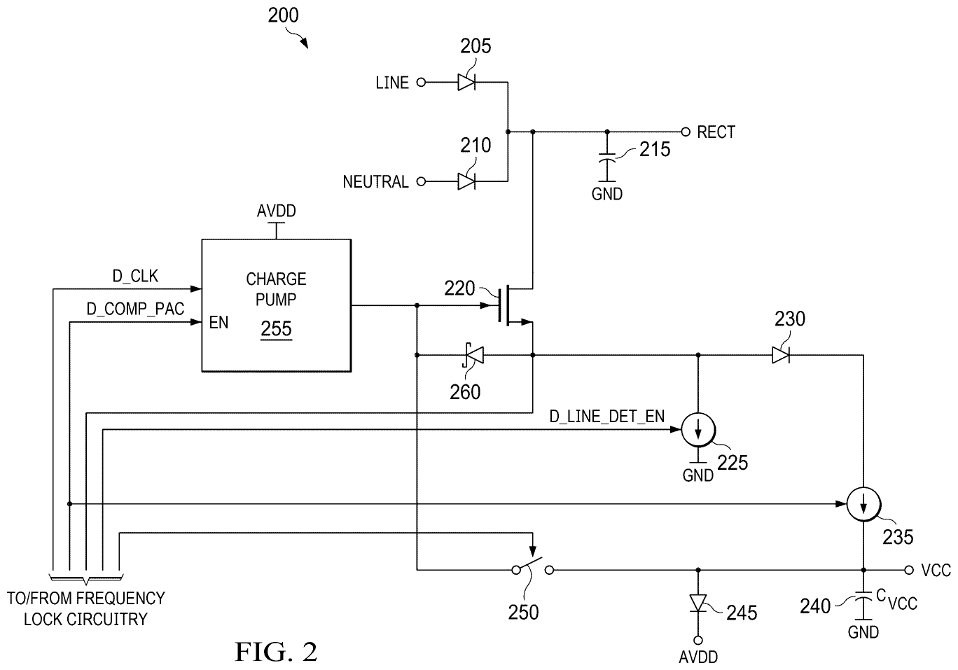

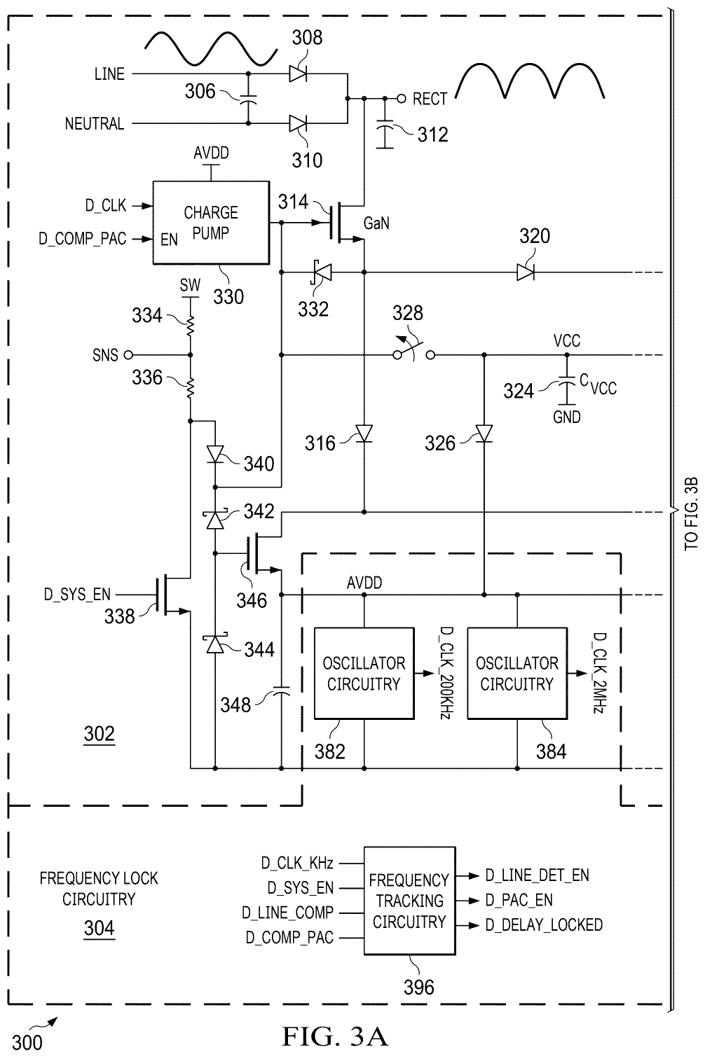

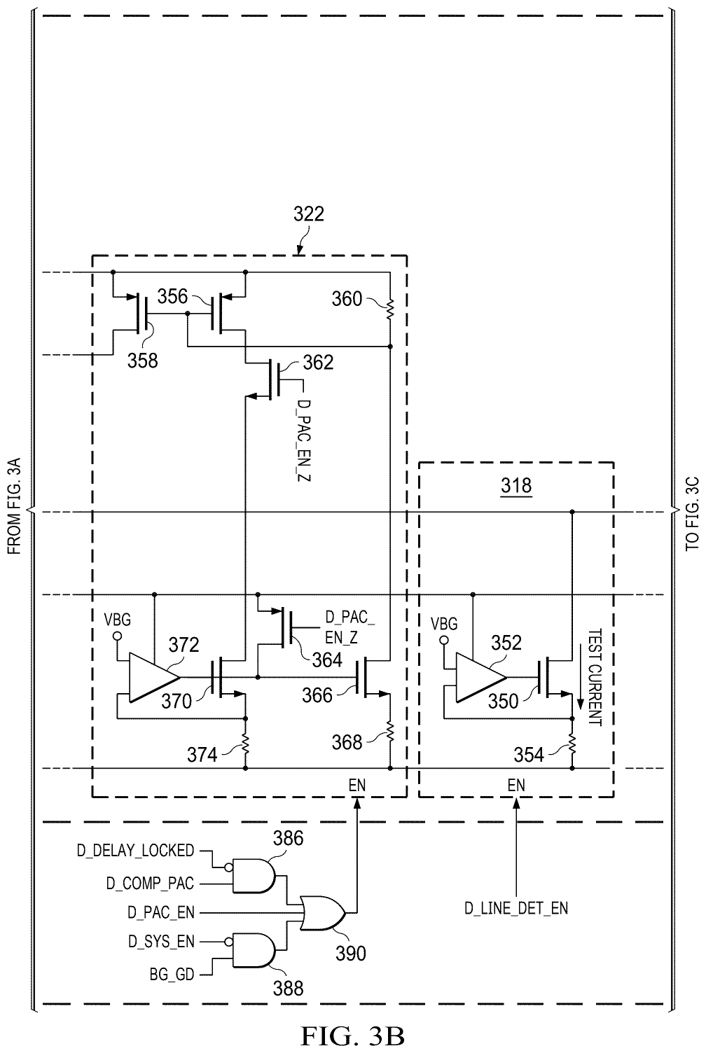

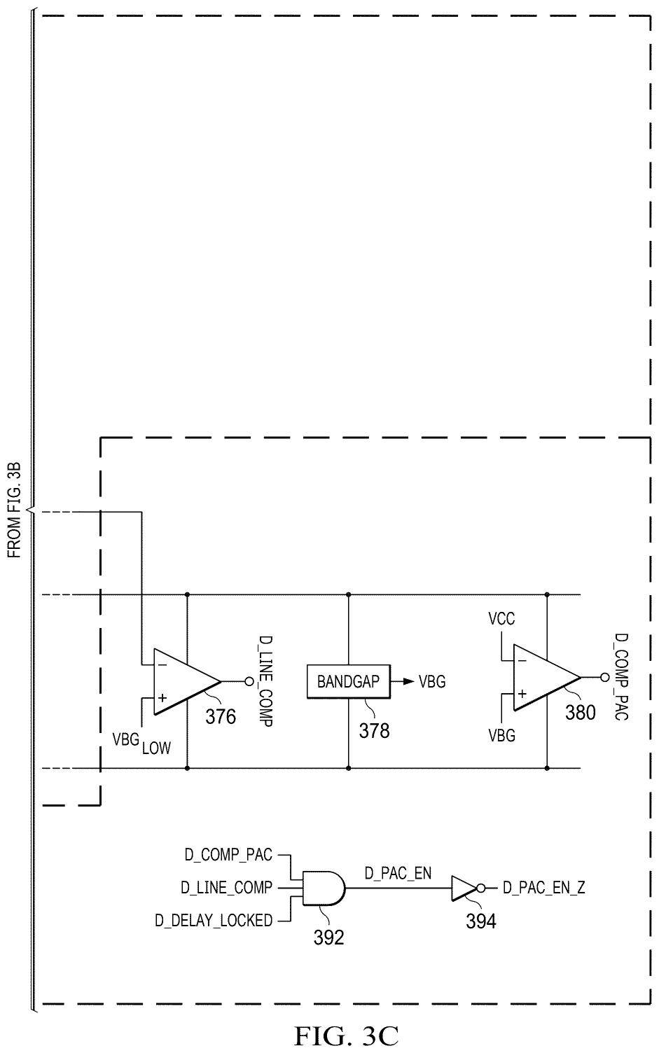

The PAC converter circuitry 140 has a first terminal, a second terminal, a third terminal, a fourth terminal, a fifth terminal, and a sixth terminal. The first and second terminals of the PAC converter circuitry 140 are coupled to the AC power supply 110. The third and fourth terminals of the PAC converter circuitry 140 are coupled to the load 130. The fifth and sixth terminals of the PAC converter circuitry 140 are coupled to the frequency lock circuitry 150. Examples of the PAC converter circuitry 140 are illustrated and described in connection with FIGS. 2 and 3, below. Example operations of the PAC converter circuitry 140 are illustrated and described in connection with FIGS. 5 and 6, below.

The frequency lock circuitry 150 has a first terminal and a second terminal coupled to the PAC converter circuitry 140. In some examples, the frequency lock circuitry 150 includes any number of terminals coupled to the PAC converter circuitry 140. An example of the frequency lock circuitry 150 is illustrated and described in connection with FIG. 3, below. Example operations of the PAC converter circuitry 140 are illustrated and described in connection with FIGS. 5 and 6, below. Advantageously, the frequency lock circuitry 150 opportunistically controls currents of the PAC converter circuitry 140 based on determined durations of the line signal.

FIG. 2 is a schematic diagram of example PAC converter circuitry 200, which is an example of the PAC converter circuitry 140 of FIG. 1. In the example of FIG. 2, the PAC converter circuitry 200 includes a first diode 205, a second diode 210, a first capacitor 215, a transistor 220, first current source circuitry 225, a third diode 230, second current source circuitry 235, a second capacitor 240, a fourth diode 245, a switch 250, charge pump circuitry 255, and a fifth diode 260. The PAC converter circuitry 200 includes a first input terminal, a second input terminal, a first output terminal, a second output terminal, and third output terminals. The first input terminal of the PAC converter circuitry 200 is structured to be coupled to the AC power supply 110 of FIG. 1, which supplies the line signal (LINE). The second input terminal of the PAC converter circuitry 200 is structured to be coupled to the AC power supply 110, which supplies the neutral potential (NEUTRAL). The first output terminal of the PAC converter circuitry 200 is structured to be coupled to the load 130 of FIG. 1, which receives the first supply voltage (VCC) from the PAC converter circuitry 200. The second output terminal of the PAC converter circuitry 200 is structured to be coupled to the load 130, which receives the second supply voltage (AVDD) from the PAC converter circuitry 200. The third output terminals of the PAC converter circuitry 200 are structured to be coupled to the frequency lock circuitry 150 of FIG. 1. Example operations of the PAC converter circuitry 200 are illustrated and described in connection with FIGS. 5 and 6, below.

The diode 205 has a first terminal and a second terminal. The first terminal of the diode 205 is coupled to the first input terminal of the PAC converter circuitry 200, which supplies the line signal. The second terminal of the diode 205 is coupled to the diode 210, the capacitor 215, and the transistor 220.

The diode 210 has a first terminal and a second terminal. The first terminal of the diode 210 is coupled to the second input terminal of the PAC converter circuitry 200, which supplies the neutral potential. The second terminal of the diode 210 is coupled to the diode 205, the capacitor 215, and the transistor 220. In the example of FIG. 2, the diodes 205, 210 are structured as rectifier circuitry, which rectifies the line signal in relation to the neutral potential to generate a rectified signal (RECT). An example of the rectified signal is illustrated and described in connection with FIG. 7, below.

The capacitor 215 has a first terminal and a second terminal. The first terminal of the capacitor 215 is coupled to the diodes 205, 210 and the transistor 220. The second terminal of the capacitor 215 is coupled to a common terminal, which supplies a common potential (e.g., ground). In some examples, the capacitor 215 is an illustrative representation of a parasitic capacitance. In such examples, the capacitor 215 represents the capacitance formed between the packaging of the PAC converter circuitry 200 and a common terminal, which supplies the common potential (e.g., ground). In other examples, the capacitor 215 is an intentional component, which terminates the rectified signal from the diodes 205, 210.

The transistor 220 has a first terminal, a second terminal, and a control terminal. The first terminal of the transistor 220 is coupled to the diodes 205, 210 and the capacitor 215. The second terminal of the transistor 220 is coupled to the current source circuitry 225 and the diodes 230, 260. The control terminal of the transistor 220 is coupled to the switch 250, the charge pump circuitry 255, and the diode 260. In the example of FIG. 2, the transistor 220 is an n-channel a gallium nitride (GaN) transistor. Alternatively, the transistor 220 may be an n-channel field-effect transistor (FET), an n-channel metal-oxide semiconductor field-effect transistor (MOSFET), an n-channel insulated-gate bipolar transistor (IGBT), an n-channel junction field effect transistor (JFET), an NPN bipolar junction transistor (BJT) or, with slight modifications, a p-type equivalent device. The transistor 220 may be a depletion mode device, a drain-extended device, an enhancement mode device, a natural transistor or other type of device structure transistor. Furthermore, the transistor 220 may be implemented in/over a silicon substrate (Si), a silicon carbide substrate (SiC), or a gallium arsenide substrate (GaAs).

The current source circuitry 225 has a first terminal, a second terminal, and a control terminal. The first terminal of the current source circuitry 225 is coupled to the transistor 220 and the diodes 230, 260. The second terminal of the current source circuitry 225 is coupled to the common terminal, which supplies the common potential. The control terminal of the current source circuitry 225 is coupled to the frequency lock circuitry 150. In some examples, the frequency lock circuitry 150 uses a line detect enable signal (D_LINE_DET_EN) to control the current source circuitry 225. In the example of FIG. 2, the current source circuitry 225 is configured to supply current to the common terminal, which drives the rectified signal to a zero-crossing. An example of the current source circuitry 225 is illustrated and described in connection with FIG. 3B, below.

The diode 230 has a first terminal and a second terminal. The first terminal of the diode 230 is coupled to the transistor 220, the current source circuitry 225, and the diode 260. The second terminal of the diode 230 is coupled to the current source circuitry 235. In the example of FIG. 2, the diode 230 isolates the current source circuitry 225 from the current source circuitry 235.

The current source circuitry 235 has a first terminal, a second terminal, and a control terminal. The first terminal of the current source circuitry 235 is coupled to the diode 230. The second terminal of the current source circuitry 235 is coupled to the capacitor 240, the diode 245, and the switch 250. The control terminal of the current source circuitry 235 is coupled to the frequency lock circuitry 150. In some examples, the frequency lock circuitry 150 uses a PAC enable signal (D_PAC_EN) to control the current source circuitry 235. In the example of FIG. 2, the current source circuitry 235 is configured to supply current to the capacitor 240, the diode 245, and the switch 250. An example of the current source circuitry 235 is illustrated and described in connection with FIG. 3B, below.

The capacitor 240 has a first terminal and a second terminal. The first terminal of the capacitor 240 is coupled to the current source circuitry 235, the diode 245, the switch 250, and the first output terminal of the PAC converter circuitry 200, which supplies the first supply voltage. The second terminal of the capacitor 240 is coupled to the common terminal, which supplies the common potential. In the example of FIG. 2, the capacitor 240 produces the first supply voltage responsive to current from the current source circuitry 235.

The diode 245 has a first terminal and a second terminal. The first terminal of the diode 245 is coupled to the current source circuitry 235, the capacitor 240, the switch 250, and the first output terminal of the PAC converter circuitry 200. The second terminal of the diode 245 is coupled to the second output terminal of the PAC converter circuitry 200, which supplies the second supply voltage. In the example of FIG. 2, the diode 245 sets the second supply voltage to the first supply voltage minus the voltage drop across the diode 245.

The switch 250 has a first terminal, a second terminal, and a control terminal. The first terminal of the switch 250 is coupled to the current source circuitry 235, the capacitor 240, and the diode 245. The second terminal of the switch 250 is coupled to the transistor 220, the charge pump circuitry 255, and the diode 260. The control terminal of the switch 250 is coupled to the frequency lock circuitry 150.

The charge pump circuitry 255 has a first terminal, a second terminal, a third terminal, and a fourth terminal. The first and second terminals of the charge pump circuitry 255 are coupled to the frequency lock circuitry 150, which supplies a reference clock signal (CLK_2MHz) and the comparison PAC signal (D_COMP_PAC). The third terminal of the charge pump circuitry 255 is coupled to the diode 245 and the second output terminal of the 200, which supplies the second supply voltage. The fourth terminal of the charge pump circuitry 255 is coupled to the transistor 220, the switch 250, and the diode 260. In the example of FIG. 2, the charge pump circuitry 255 boosts the second supply voltage to control the transistor 220.

The diode 260 has a first terminal and a second terminal. The first terminal of the diode 260 is coupled to the transistor 220, the current source circuitry 225, the diode 230, and the frequency lock circuitry 150. The second terminal of the diode 260 is coupled to the transistor 220, the switch 250, and the charge pump circuitry 255. In the example of FIG. 2, the diode 260 is structured as clamp circuitry, which clamps the drain-to-source voltage of the transistor 220 to a clamp voltage.

Example operations of the PAC converter circuitry 200 are illustrated and described in connection with FIGS. 5 and 6, below. Advantageously, the frequency lock circuitry 150 controls the current source circuitry 225, 235. Advantageously, disabling the current source circuitry 225 decreases the power consumption of the PAC converter circuitry 200.

FIGS. 3A, 3B, and 3C form a schematic diagram of an example AC to DC converter circuitry 300, which is an example of the AC to DC converter circuitry 120 of FIG. 1. In the example of FIGS. 3A, 3B, and 3C, the AC to DC converter circuitry 300 includes PAC converter circuitry 302 and frequency lock circuitry 304. The example PAC converter circuitry 302 of FIGS. 3A, 3B, and 3C includes an first example capacitor 306, a first example diode 308, a second example diode 310, a second example capacitor 312, a first example transistor 314, a third example diode 316, first example current source circuitry 318, a fourth example diode 320, second example current source circuitry 322, a third example capacitor 324, a fifth example diode 326, an example switch 328, example charge pump circuitry 330, a sixth example diode 332, a first example resistor 334, a second example resistor 336, a second example transistor 338, a seventh example diode 340, an eighth example diode 342, a ninth example diode 344, a third example transistor 346, and a fourth example capacitor 348. The example current source circuitry 318 of FIG. 3B includes an example transistor 350, example amplifier circuitry 352, and an example resistor 354. The example current source circuitry 322 of FIG. 3B includes a first example transistor 356, a second example transistor 358, a first example resistor 360, a third example transistor 362, a fourth example transistor 364, a fifth example transistor 366, a second example resistor 368, a sixth example transistor 370, example amplifier circuitry 372, and a third example resistor 374. The example frequency lock circuitry 304 of FIGS. 3A, 3B, and 3C includes first example amplifier circuitry 376, example bandgap reference circuitry 378, second example amplifier circuitry 380, first example oscillator circuitry 382, second example oscillator circuitry 384, a first example logic device 386, a second example logic device 388, a third example logic device 390, a fourth example logic device 392, an example inverter 394, and example frequency tracking circuitry 396.

The AC to DC converter circuitry 300 has a first input terminal, a second input terminal, a third input terminal, a first output terminal, and a second output terminal. The first input terminal of the AC to DC converter circuitry 300 is structured to be coupled to the AC power supply 110 of FIG. 1, which supplies the line signal (LINE). The second input terminal of the AC to DC converter circuitry 300 is structured to be coupled to the AC power supply 110, which supplies the neutral potential (NEUTRAL). The third input terminal of the AC to DC converter circuitry 300 is structured to be coupled to external circuitry, which supplies a system enable signal (D_SYS_EN). The first output terminal of the AC to DC converter circuitry 300 is structured to be coupled to the load 130 of FIG. 1, which receives the first supply voltage (VCC). The second output terminal of the AC to DC converter circuitry 300 is structured to be coupled to the load 130, which receives the second supply voltage (AVDD).

The PAC converter circuitry 302 is coupled to the first, second, and third input terminals of the AC to DC converter circuitry 300, the first and second output terminals of the AC to DC converter circuitry 300, and the frequency lock circuitry 304. The PAC converter circuitry 302 is another example of the PAC converter circuitry 140, 200 of FIGS. 1 and 2. Example operations of the PAC converter circuitry 302 are further illustrated and described in connection with FIGS. 5 and 6, below.

The frequency lock circuitry 304 is coupled to the third input terminal of the AC to DC converter circuitry 300, the first and second output terminals of the AC to DC converter circuitry 300, and the PAC converter circuitry 302. The frequency lock circuitry 304 is an example of the frequency lock circuitry 150 of FIG. 1. Example operations of the frequency lock circuitry 304 are further illustrated and described in connection with FIGS. 5 and 6, below.

The capacitor 306 has a first terminal and a second terminal. The first terminal of the capacitor 306 is coupled to the diode 308 and the first input terminal of the AC to DC converter circuitry 300, which supplies the line signal. The second terminal of the capacitor 306 is coupled to the diode 310 and the second input terminal of the AC to DC converter circuitry 300, which supplies the neutral potential. In some examples, the capacitor 306 is referred to as a decoupling capacitor.

The diode 308 has a first terminal and a second terminal. The first terminal of the diode 308 is coupled to the capacitor 306 and the first input terminal of the AC to DC converter circuitry 300, which supplies the line signal. The second terminal of the diode 308 is coupled to the diode 310, the capacitor 312, and the transistor 314. The diode 308 is another example of the diode 205 of FIG. 2.

The diode 310 has a first terminal and a second terminal. The first terminal of the diode 310 is coupled to the capacitor 306 and the second input terminal of the AC to DC converter circuitry 300, which supplies the neutral potential. The second terminal of the diode 310 is coupled to the diode 308, the capacitor 312, and the transistor 314. The diode 310 is another example of the diode 210 of FIG. 2. In the example of FIG. 3A, the diodes 308, 310 form rectifier circuitry, which rectifies the line signal to produce the rectified signal (RECT).

The capacitor 312 has a first terminal and a second terminal. The first terminal of the capacitor 312 is coupled to the diodes 308, 310 and the transistor 314. The second terminal of the capacitor 312 is coupled to a common terminal, which supplies the common potential (e.g., ground). The capacitor 312 is another example of the capacitor 215 of FIG. 2. In some examples, the capacitor 312 is an illustrative representation of a parasitic capacitance. In such examples, the capacitor 312 represents the capacitance formed between the packaging of the AC to DC converter circuitry 300 and the common terminal, which supplies the common potential. In other examples, the capacitor 312 is an intentional component, which terminates the rectified signal from the diodes 308, 310.

The transistor 314 has a first terminal, a second terminal, and a control terminal. The first terminal of the transistor 314 is coupled to the diodes 308, 310 and the capacitor 312. The second terminal of the transistor 314 is coupled to the diodes 316, 320, 332. The control terminal of the transistor 314 is coupled to the switch 328, the charge pump circuitry 330, and the diodes 332, 340, 342. The transistor 314 is another example of the transistor 220 of FIG. 2.

The diode 316 has a first terminal and a second terminal. The first terminal of the diode 316 is coupled to the transistor 314 and the diodes 320, 332. The second terminal of the diode 316 is coupled to the current source circuitry 318, the transistor 346, and the amplifier circuitry 376.

The current source circuitry 318 has a first terminal, a second terminal, a third terminal, a fourth terminal, and a fifth terminal. The first terminal of the current source circuitry 318 is coupled to the diode 316, the transistor 346, and the amplifier circuitry 376. The second terminal of the current source circuitry 318 is coupled to the second output terminal of the AC to DC converter circuitry 300, which supplies the second output voltage. The third terminal of the current source circuitry 318 is coupled to the common terminal, which supplies the common potential. The fourth terminal of the current source circuitry 318 is coupled to the bandgap reference circuitry 378, which supplies a reference voltage (VBG). The fifth terminal of the current source circuitry 318 is coupled to the frequency tracking circuitry 396, which supplies the line detect enable signal (D_LINE_DET_EN). An example of the line detect enable signal is illustrated and described in connection with FIG. 7, below. The current source circuitry 318 is another example of the current source circuitry 225 of FIG. 2.

The diode 320 has a first terminal and a second terminal. The first terminal of the diode 320 is coupled to the transistor 314 and the diodes 316, 332. The second terminal of the diode 320 is coupled to the current source circuitry 322. The diode 320 is an example of the diode 230 of FIG. 2, which isolates the current source circuitry 318 from the current source circuitry 322.

The current source circuitry 322 has a first terminal, a second terminal, a third terminal, a fourth terminal, a fifth terminal, and a sixth terminal. The first terminal of the current source circuitry 322 is coupled to the diode 320. The second terminal of the current source circuitry 322 is coupled to the first output terminal of the AC to DC converter circuitry 300, which supplies the first output voltage. The third terminal of the current source circuitry 322 is coupled to the common terminal, which supplies the common potential. The fourth terminal of the current source circuitry 322 is coupled to the bandgap reference circuitry 378, which supplies the reference voltage. The fifth terminal of the current source circuitry 322 is coupled to the inverter 394, which supplies an inverted phase angle control enable signal (D_PAC_EN_Z). The sixth terminal of the current source circuitry 322 is coupled to the logic device 390. The current source circuitry 322 is another example of the current source circuitry 235 of FIG. 2.

The capacitor 324 has a first terminal and a second terminal. The first terminal of the capacitor 324 is coupled to the first output terminal of the AC to DC converter circuitry 300, which supplies the first supply voltage. The second terminal of the capacitor 324 is coupled to the common terminal, which supplies the common potential. The capacitor 324 is an example of the capacitor 240 of FIG. 2.

The diode 326 has a first terminal and a second terminal. The first terminal of the diode 326 is coupled to the first output terminal of the AC to DC converter circuitry 300, which supplies the first supply voltage. The second terminal of the diode 326 is coupled to the second output terminal of the AC to DC converter circuitry 300, which supplies the second supply voltage. The diode 326 is another example of the diode 245 of FIG. 2.

The switch 328 has a first terminal, a second terminal, and a control terminal. The first terminal of the switch 328 is coupled to the first output terminal of the AC to DC converter circuitry 300, which supplies the first output voltage. The second terminal of the switch 328 is coupled to the transistor 314, the charge pump circuitry 330, and the diodes 332, 340, 342. The control terminal of the switch i328 is coupled to the logic device 392 and the inverter 394, which supplies the inverted PAC enable signal (D_PAC_EN_Z). The switch 328 is another example of the switch 250 of FIG. 2.

The charge pump circuitry 330 has a first terminal, a second terminal, a third terminal, and a fourth terminal. The first terminal of the charge pump circuitry 330 is coupled to the transistor 314, the switch 328, and the diodes 332, 340, 342. The second terminal of the charge pump circuitry 330 is coupled to the second output terminal of the AC to DC converter circuitry 300, which supplies the second supply voltage. The third terminal of the charge pump circuitry 330 is coupled to the oscillator circuitry 384. The fourth terminal of the charge pump circuitry 330 is coupled to the amplifier circuitry 380, which supplies a comparison PAC signal (D_COMP_PAC). The charge pump circuitry 330 is another example of the charge pump circuitry 255 of FIG. 2.

The diode 332 has a first terminal and a second terminal. The first terminal of the diode 332 is coupled to the transistor 314 and the diodes 316, 320. The second terminal of the diode 332 is coupled to the transistor 314, the switch 328, the charge pump circuitry 330, and the diodes 340, 342. The diode 332 is an example of the diode 260 of FIG. 2. In the example of FIG. 3A, the diode 332 is a Zener diode, which clamps the gate-to-source voltage of the transistor 314. In other examples, the Zener diode may be replaced with an alternative type of voltage clamp circuitry.

The resistor 334 has a first terminal and a second terminal. The first terminal of the resistor 334 is coupled to a switching input terminal, which supplies a switching signal (SW). The switching signal represents a maximum value of an input voltage of the rectified signal plus an output voltage of the PAC converter circuitry 140, 200, 302 times a turns ratio of the transformer of the AC power supply 110. The second terminal of the resistor 334 is coupled to the resistor 336. The resistor 336 has a first terminal and a second terminal. The first terminal of the resistor 336 is coupled to the resistor 334. The second terminal of the resistor 336 is coupled to the transistor 338 and the diode 340. In the example of FIG. 3, the resistors 334, 336 are structured as voltage divider circuitry, which divides the voltage of the switching signal.

The transistor 338 has a first terminal, a second terminal, and a control terminal. The first terminal of the transistor 338 is coupled to the resistor 336 and the diode 340. The second terminal of the transistor 338 is coupled to the common terminal, which supplies the common potential. The control terminal of the transistor 338 is coupled to the third input terminal of the AC to DC converter circuitry 300, which supplies the system enable signal.

The diode 340 has a first terminal and a second terminal. The first terminal of the diode 340 is coupled to the resistor 336 and the transistor 338. The second terminal of the diode 340 is coupled to the transistor 314, the switch 328, the charge pump circuitry 330, and the diodes 332, 342.

The diode 342 has a first terminal and a second terminal. The first terminal of the diode 342 is coupled to the transistor 314, the switch 328, the charge pump circuitry 330, and the diodes 332, 340. The second terminal of the diode 342 is coupled to the diode 344 and the transistor 346. In the example of FIG. 3A, the diode 342 is a Zener diode, which clamps the gate voltage of the transistor 346. In other examples, the Zener diode may be replaced with an alternative type of voltage clamp circuitry.

The diode 344 has a first terminal and a second terminal. The first terminal of the diode 344 is coupled to the diode 342 and the transistor 346. The second terminal of the diode 344 is coupled to the common terminal, which supplies the common potential. In the example of FIG. 3A, the diode 344 is a Zener diode, which clamps the gate voltage of the transistor 346. In other examples, the Zener diode may be replaced with an alternative type of voltage clamp circuitry.

The transistor 346 has a first terminal, a second terminal, and a control terminal. The first terminal of the transistor 346 is coupled to the diode 316, the current source circuitry 318, and the amplifier circuitry 376. The second terminal of the transistor 346 is coupled to the second output terminal of the AC to DC converter circuitry 300, which supplies the second supply voltage. The control terminal of the transistor 346 is coupled to the diodes 342, 344. In example operations, when the system enable signal is not set to a logic high, the transistor 338 is off, which forward biases the diode 340 and sets the voltage across the diodes 342, 344. In such examples, the clamp voltage of the diodes 342, 344 turn on the transistor 346, which couples the second output terminal of the AC to DC converter circuitry 300 to the diode 316.

The capacitor 348 has a first terminal and a second terminal. The first terminal of the capacitor 348 is coupled to the second output terminal of the AC to DC converter circuitry 300, which supplies the second output voltage. The second terminal of the capacitor 348 is coupled to the common terminal, which supplies the common potential.

The transistor 350 has a first terminal, a second terminal, and a control terminal. The first terminal of the transistor 350 is coupled to the diode 316, the transistor 346, and the amplifier circuitry 376. The second terminal of the transistor 350 is coupled to the amplifier circuitry 352 and the resistor 354. The control terminal of the transistor 350 is coupled to the amplifier circuitry 352.

The amplifier circuitry 352 has a first terminal, a second terminal, a third terminal, and a fourth terminal. The first terminal of the amplifier circuitry 352 (also referred to as an input terminal) is coupled to the transistor 350 and the resistor 354. The second terminal of the amplifier circuitry 352 (also referred to as an input terminal) is coupled to the bandgap reference circuitry 378, which supplies the reference voltage. The third terminal of the amplifier circuitry 352 (also referred to as a supply terminal) is coupled to the second output terminal of the AC to DC converter circuitry 300, which supplies the second output voltage. The fourth terminal of the amplifier circuitry 352 (also referred to as an output terminal) is coupled to the transistor 350.

The resistor 354 has a first terminal and a second terminal. The first terminal of the resistor 354 is coupled to the transistor 350 and the amplifier circuitry 352. The second terminal of the resistor 354 is coupled to the common terminal, which supplies the common potential.

The transistor 356 has a first terminal, a second terminal, and a control terminal. The first terminal of the transistor 356 is coupled to the diode 320, the transistor 358, and the resistor 360. The second terminal of the transistor 356 is coupled to the transistor 362. The control terminal of the transistor 356 is coupled to the transistors 358, 366 and the resistor 360.

The transistor 358 has a first terminal, a second terminal, and a control terminal. The first terminal of the transistor 358 is coupled to the diode 320, the transistor 356, and the resistor 360. The second terminal of the transistor 358 is coupled to the capacitor 324, the diode 326, and the first output terminal of the AC to DC converter circuitry 300, which supplies the first supply voltage. The control terminal of the transistor 358 is coupled to the transistors 356, 366, and the resistor 360.

The resistor 360 has a first terminal and a second terminal. The first terminal of the resistor 360 is coupled to the diode 320 and the transistors 356, 358. The second terminal of the resistor 360 is coupled to the transistors 356, 358, 366. In the example of FIG. 3B, the transistors 356, 358 are structured as current mirror circuitry, which mirrors the current through the resistor 360 and the transistor 366.

The transistor 362 has a first terminal, a second terminal, and a control terminal. The first terminal of the transistor 362 is coupled to the transistor 356. The second terminal of the transistor 362 is coupled to the transistor 370. The control terminal of the transistor 362 is coupled to the inverter 394, which supplies the inverted PAC enable signal.

The transistor 364 has a first terminal, a second terminal, and a control terminal. The first terminal of the transistor 364 is coupled to the second output terminal of the AC to DC converter circuitry 300, which supplies the second supply voltage. The second terminal of the transistor 364 is coupled to the transistors 366, 370 and the amplifier circuitry 372. The control terminal of the transistor 364 is coupled to the inverter 394, which supplies the inverted PAC enable signal.

The transistor 366 has a first terminal, a second terminal, and a control terminal. The first terminal of the transistor 366 is coupled to the transistors 356, 358 and the resistor 360. The second terminal of the transistor 366 is coupled to the resistor 368. The control terminal of the transistor 366 is coupled to the transistors 364, 370 and the amplifier circuitry 372.

The resistor 368 has a first terminal and a second terminal. The first terminal of the resistor 368 is coupled to the transistor 366. The second terminal of the resistor 368 is coupled to the common terminal, which supplies the common potential.

The transistor 370 has a first terminal, a second terminal, and a control terminal. The first terminal of the transistor 370 is coupled to the transistor 362. The second terminal of the transistor 370 is coupled to the amplifier circuitry 372 and the resistor 374. The control terminal of the transistor 370 is coupled to the transistors 364, 366 and the amplifier circuitry 372.

The amplifier circuitry 372 has a first terminal, a second terminal, a third terminal, and a fourth terminal. The first terminal of the amplifier circuitry 372 (also referred to as an input terminal) is coupled to the transistor 370 and the resistor 374. The second terminal of the amplifier circuitry 372 (also referred to as an input terminal) is coupled to the bandgap reference circuitry 378, which supplies the reference voltage. The third terminal of the amplifier circuitry 372 (also referred to as a supply terminal) is coupled to the second output terminal of the AC to DC converter circuitry 300, which supplies the second supply voltage. The fourth terminal of the amplifier circuitry 372 (also referred to as an output terminal) is coupled to the transistors 364, 366, 370.

The resistor 374 has a first terminal and a second terminal. The first terminal of the resistor 374 is coupled to the transistor 370 and the amplifier circuitry 372. The second terminal of the resistor 374 is coupled to the common terminal, which supplies the common potential.

The amplifier circuitry 376 has a first terminal, a second terminal, a third terminal, a fourth terminal, and a fifth terminal. The first terminal of the amplifier circuitry 376 is coupled to the diode 316 and the transistor 346. The second terminal of the amplifier circuitry 376 is coupled to the bandgap reference circuitry 378, which supplies a low reference voltage (VBG_{LOW}). In some examples, the AC to DC converter circuitry 300 includes voltage divider circuitry to generate the low reference voltage using the reference voltage from the bandgap reference circuitry 378. The low reference voltage represents a voltage of the rectified signal that corresponds to a zero crossing. In some examples, the low reference voltage is a voltage greater than zero. In such examples, the amplifier circuitry 376 is structured to detect the rectified signal is approaching a zero-crossing. The third terminal of the amplifier circuitry 376 is coupled to the second output terminal of the AC to DC converter circuitry 300, which supplies the second supply voltage. The fourth terminal of the amplifier circuitry 376 is coupled to the common terminal, which supplies the common potential. The fifth terminal of the amplifier circuitry 376 is coupled to the frequency tracking circuitry 396. In the example of FIG. 3C, the amplifier circuitry 376 supplies a line comparison signal (D_LINE_COMP), which represents a comparison of the rectified input signal (RECT) from the diodes 308, 310 to the low reference voltage from the bandgap reference circuitry 378. In some examples, the line comparison signal represents the rectified input signal is in proximity to or at a zero-crossing.

The bandgap reference circuitry 378 has a first terminal, a second terminal, and a third terminal. The first terminal of the bandgap reference circuitry 378 is coupled to the second output terminal of the AC to DC converter circuitry 300, which supplies the second supply voltage. The second terminal of the bandgap reference circuitry 378 is coupled to the common terminal, which supplies the common potential. The third terminal of the bandgap reference circuitry 378 is coupled to the amplifier circuitry 352, 372, 376, 380. In the example of FIG. 3C, the bandgap reference circuitry 378 generates the reference voltage (VBG) responsive to receiving the second supply voltage. In some examples, the AC to DC converter circuitry 300 may include voltage divider circuitry or alternative circuitry to generate a plurality of reference voltages for the amplifier circuitry 352, 372, 376, 380. For example, the AC to DC converter circuitry 300 includes voltage divider circuitry to supply the low reference voltage (VBG_{LOW}) to the amplifier circuitry 376.

The amplifier circuitry 380 has a first terminal, a second terminal, a third terminal, a fourth terminal, and a fifth terminal. The first terminal of the amplifier circuitry 380 is coupled to the first output terminal of the AC to DC converter circuitry 300, which supplies the first supply voltage. The second terminal of the amplifier circuitry 380 is coupled to the bandgap reference circuitry 378, which supplies the reference voltage. The third terminal of the amplifier circuitry 380 is coupled to the second output terminal of the AC to DC converter circuitry 300, which supplies the second supply voltage. The fourth terminal of the amplifier circuitry 380 is coupled to the common terminal, which supplies the common potential. The fifth terminal of the amplifier circuitry 380 is coupled to the charge pump circuitry 330, the logic device 386, 392, and the frequency tracking circuitry 396. In the example of FIG. 3C, the amplifier circuitry 380 supplies a comparison PAC signal (D_COMP_PAC), which represents a comparison of the first supply voltage at the first output terminal of the AC to DC converter circuitry 300 to the reference voltage from the bandgap reference circuitry 378. In some examples, the reference voltage represents a desired first supply voltage. In other examples, the reference voltage represents a maximum voltage at which the PAC converter circuitry 302 may safely operate at.

The oscillator circuitry 382 has a first terminal, a second terminal, and a third terminal. The first terminal of the oscillator circuitry 382 is coupled to the second output terminal of the AC to DC converter circuitry 300, which supplies the second supply voltage. The second terminal of the oscillator circuitry 382 is coupled to the common terminal, which supplies the common potential. The third terminal of the oscillator circuitry 382 is coupled to the frequency tracking circuitry 396. In the example of FIG. 3A, the oscillator circuitry 382 supplies a first clock signal (D_CLK_200KHz).

The oscillator circuitry 384 has a first terminal, a second terminal, and a third terminal. The first terminal of the oscillator circuitry 384 is coupled to the second output terminal of the AC to DC converter circuitry 300, which supplies the second supply voltage. The second terminal of the oscillator circuitry 384 is coupled to the common terminal, which supplies the common potential. The third terminal of the oscillator circuitry 384 is coupled to the charge pump circuitry 330. In the example of FIG. 3A, the oscillator circuitry 384 supplies a second clock signal (D_CLK_2MHz).

The logic device 386 has a first input terminal, a second input terminal, and an output terminal. The first input terminal of the logic device 386 is coupled to the frequency tracking circuitry 396, which supplies a delay lock signal (D_DELAY_LOCKED). The second input terminal of the logic device 386 is coupled to the amplifier circuitry 380, which supplies the comparison PAC signal. The output terminal of the logic device 386 is coupled to the logic device 390. In the example of FIG. 3B, the logic device 386 is an AND gate having an inverting input.

The logic device 388 has a first input terminal, a second input terminal, and an output terminal. The first input terminal of the logic device 388 is coupled to external circuitry, which supplies the system enable signal. The second input terminal of the logic device 388 is coupled to external circuitry, which supplies a bandgap reference (BG_GD). The output terminal of the logic device 388 is coupled to the logic device 390. In the example of FIG. 3B, the logic device 386 is an AND gate having an inverting input.

The logic device 390 has a first input terminal, a second input terminal, a third input terminal, and an output terminal. The first input terminal of the logic device 390 is coupled to the logic device 386. The second input terminal of the logic device 390 is coupled to the frequency tracking circuitry 396, which supplies the PAC enable signal (D_PAC_EN). The third input terminal of the logic device 390 is coupled to the logic device 388. The output terminal of the logic device 390 is coupled to the current source circuitry 322. In the example of FIG. 3B, the logic device 390 is an OR gate.

The logic device 392 has a first input terminal, a second input terminal, a third input terminal, and an output terminal. The first input terminal of the logic device 392 is coupled to the amplifier circuitry 380, which supplies the comparison PAC signal. The second input terminal of the logic device 392 is coupled to the amplifier circuitry 376, which supplies the line comparison signal. The third input terminal of the logic device 392 is coupled to the frequency tracking circuitry 396, which supplies the delay lock signal. The output terminal of the logic device 392 is coupled to the logic device 390 and the inverter 394. In the example of FIG. 3C, the logic device 392 is an AND gate. Also, the logic device 392 supplies the PAC enable signal. Alternatively, the logic device 392 may be replaced with or included in the frequency tracking circuitry 396.

The inverter 394 has a first terminal and a second terminal. The first terminal of the inverter 394 is coupled to the logic device 392, which supplies the PAC enable signal. The second terminal of the inverter 394 is coupled to the transistors 362, 364. In the example of FIG. 3C, the inverter 394 supplies the inverted PAC enable signal.

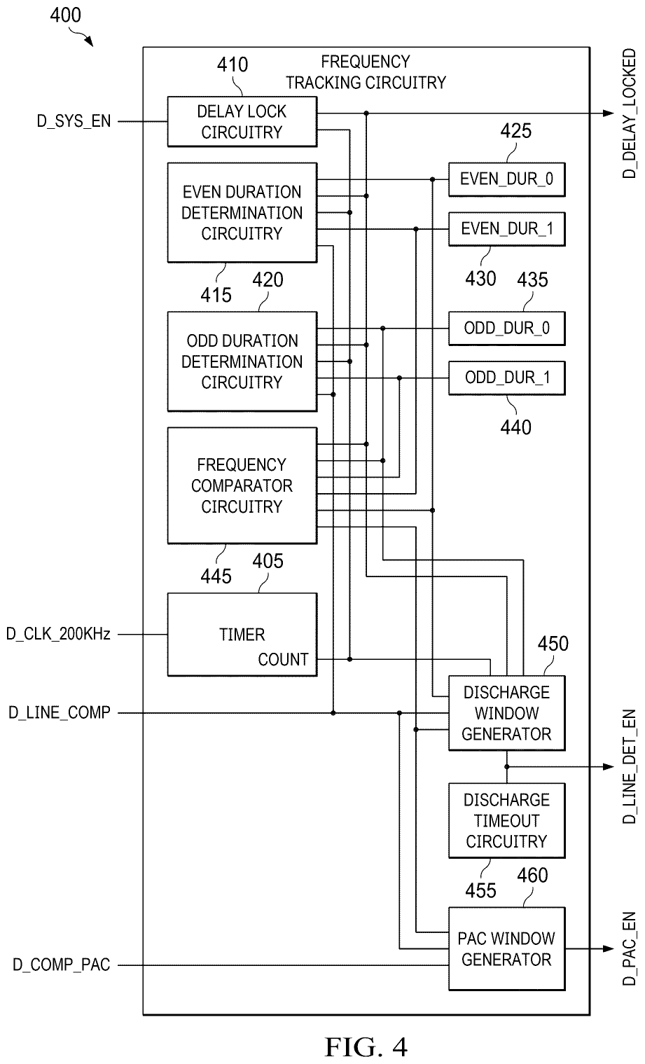

The frequency tracking circuitry 396 has a first terminal, a second terminal, a third terminal, a fourth terminal, a fifth terminal, a sixth terminal, and a seventh terminal. The first terminal of the frequency tracking circuitry 396 is coupled to the oscillator circuitry 382, which supplies the first clock signal. The second terminal of the frequency tracking circuitry 396 is coupled to the external circuitry, which supplies the system enable signal. The third terminal of the frequency tracking circuitry 396 is coupled to the amplifier circuitry 376, which supplies the line comparison signal. The fourth terminal of the frequency tracking circuitry 396 is coupled to the amplifier circuitry 380, which supplies the comparison PAC signal. The fifth terminal of the frequency tracking circuitry 396 is coupled to the current source circuitry 318, which receives the line detect enable signal. The sixth terminal of the frequency tracking circuitry 396 is coupled to the logic device 390 and the inverter 394, which receive the PAC enable signal. The seventh terminal of the frequency tracking circuitry 396 is coupled to the logic devices 386, 392, which receive the delay lock signal. An example of the frequency tracking circuitry 396 is further illustrated and described in connection with FIG. 4, below. Also, example operations of the frequency tracking circuitry 396 are illustrated and described in connection with FIGS. 5 and 6, below.

In the example of FIGS. 3A, 3B, and 3C, the transistors 314, 338, 346, 350, 362, 366, 370 are n-channel MOSFETs. Alternatively, the transistors 314, 338, 346, 350, 362, 366, 370 may be n-channel FETs, n-channel IGBTs, n-channel JFETs, NPN BJTs or, with slight modifications, p-type equivalent devices. In the example of FIGS. 3A, 3B, and 3C, the transistors 356, 358, 364 are p-channel MOSFETs. Alternatively, the transistors 356, 358, 364 may be p-channel FETs, p-channel IGBTs, p-channel JFETs, PNP BJTs, or, with slight modifications, N-type equivalent devices. The transistors 314, 338, 346, 350, 356, 358, 362, 364, 366, 370 may be depletion mode devices, drain-extended devices, enhancement mode devices, natural transistors or other type of device structure transistors. Furthermore, the transistors 314, 338, 346, 350, 356, 358, 362, 364, 366, 370 may be implemented in/over a silicon substrate (Si), a silicon carbide substrate (SiC), a gallium nitride substrate (GaN) or a gallium arsenide substrate (GaAs).

FIG. 4 is a block diagram of example frequency tracking circuitry 400, which is an example of the frequency tracking circuitry 396 of FIG. 3A. In the example of FIG. 4, the frequency tracking circuitry 400 includes timer circuitry 405, delay lock circuitry 410, even duration determination circuitry 415, odd duration determination circuitry 420, a first even duration 425, a second even duration 430, a first odd duration 435, a second odd duration 440, frequency comparator circuitry 445, discharge window generator circuitry 450, discharge timeout circuitry 455, and PAC window generator circuitry 460. The frequency tracking circuitry 396, 400 of FIGS. 3A and 4 may be instantiated (e.g., creating an instance of, bring into being for any length of time, materialize, implement, etc.) by programmable circuitry such as a Central Processor Unit (CPU) executing first instructions. Also or alternatively, the frequency tracking circuitry 396, 400 of FIGS. 3A and 4 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the frequency tracking circuitry 396, 400 of FIGS. 3A and 4 may, thus, be instantiated at the same or different times. Some or all of the frequency tracking circuitry 396, 400 of FIGS. 3A and 4 may be instantiated, for example, in one or more threads executing concurrently on hardware or in series on hardware. Moreover, in some examples, some or all of the frequency tracking circuitry 396, 400 of FIGS. 3A and 4 may be implemented by microprocessor circuitry executing instructions or FPGA circuitry performing operations to implement one or more virtual machines or containers.

The frequency tracking circuitry 400 has a first input terminal, a second input terminal, a third input terminal, a fourth input terminal, a first output terminal, a second output terminal, and a third output terminal. The first input terminal of the frequency tracking circuitry 400 is structured to be coupled to the oscillator circuitry 382 of FIG. 3A, which supplies a clock signal (D_CLK). For example, the oscillator circuitry 382 supplies a clock signal having two-hundred kilohertz (KHz). The second input terminal of the frequency tracking circuitry 400 is structured to be coupled to external circuitry, which supplies the system enable signal (D_SYS_EN). In some examples, the system enable signal is set responsive to receiving power from the AC power supply 110 of FIG. 1. The third input terminal of the frequency tracking circuitry 400 is coupled to the amplifier circuitry 376 of FIG. 3C, which supplies the line comparison signal (D_LINE_COMP). The line comparison signal represents a comparison of the rectified signal from the diodes 308, 310 of FIG. 3A to a low reference voltage (VBG_{LOW}). Also, the line comparison signal may be used to represent when the rectified signal is at or approaching a reference zero-crossing. The fourth input terminal of the frequency tracking circuitry 400 is structured to be coupled to the amplifier circuitry 380 of FIG. 3C, which supplies the comparison PAC signal (D_COMP_PAC). The comparison PAC signal represents a comparison of a first supply voltage (VCC) at the first output terminal of the AC to DC converter circuitry 300 to the reference voltage (VBG) from the bandgap reference circuitry 378 of FIG. 3C. Also, the comparison PAC signal may be used to set a desired supply voltage or maximum safe operating voltage.

The first output terminal of the frequency tracking circuitry 400 is structured to be coupled to the current source circuitry 318 of FIG. 3B, which receives the line detect enable signal (D_LINE_DET_EN). The line detect enable signal is a control signal, which enables (e.g., turns off) the current source circuitry 318 in response to the line comparison signal indicating a detection of a zero-crossing. The second output terminal of the frequency tracking circuitry 400 is structured to be coupled to the logic device 390 of FIG. 3B and the inverter 394 of FIG. 3C, both of which receive the PAC enable signal (D_PAC_EN). The PAC enable signal is a control signal, which enables the current source circuitry 322 of FIG. 3B responsive to a zero-crossing occurring and prior to the rectified signal increasing beyond a safe operating voltage. The third output terminal of the frequency tracking circuitry 400 is structured to be coupled to the logic devices 386, 392 of FIGS. 3B and 3C, which receive a delay lock signal (D_DELAY_LOCKED). The delay lock signal enables the current source circuitry 318 when the frequency tracking circuitry 400 is determining even and odd cycle durations of the rectified signal.

The timer circuitry 405 has a first terminal and a second terminal. The first terminal of the timer circuitry 405 is coupled to the first input terminal of the frequency tracking circuitry 400, which receives the clock signal. The second terminal of the timer circuitry 405 is coupled to the delay lock circuitry 410, the even duration determination circuitry 415, the odd duration determination circuitry 420, and the discharge window generator circuitry 450. In some examples, the timer circuitry 405 is instantiated by programmable circuitry executing timer instructions to perform operations such as those represented by the flowchart(s) of FIGS. 5 and 6.

The delay lock circuitry 410 has a first terminal, a second terminal, and a third terminal. The first terminal of the delay lock circuitry 410 is coupled to the second input terminal of the frequency tracking circuitry 400, which receives the system enable signal. The second terminal of the delay lock circuitry 410 is coupled to the timer circuitry 405, the even duration determination circuitry 415, the odd duration determination circuitry 420, and the discharge window generator circuitry 450. The third terminal of the delay lock circuitry 410 is coupled to the even duration determination circuitry 415, the odd duration determination circuitry 420, the frequency comparator circuitry 445, the discharge window generator circuitry 450, and the third output terminal of the frequency tracking circuitry 400, which supplies the delay lock signal. In some examples, delay lock circuitry 410 is instantiated by programmable circuitry executing delay lock instructions to perform operations such as those represented by the flowchart(s) of FIGS. 5 and 6.

The even duration determination circuitry 415 has a first terminal, a second terminal, a third terminal, a fourth terminal, and a fifth terminal. The first terminal of the even duration determination circuitry 415 is coupled to the timer circuitry 405, the delay lock circuitry 410, the odd duration determination circuitry 420, and the discharge window generator circuitry 450. The second terminal of the even duration determination circuitry 415 is coupled to the delay lock circuitry 410, the odd duration determination circuitry 420, the frequency comparator circuitry 445, the discharge window generator circuitry 450, and the third output terminal of the frequency tracking circuitry 400, which supplies the delay lock signal. The third terminal of the even duration determination circuitry 415 is coupled to the even duration 425, the frequency comparator circuitry 445, and the discharge window generator circuitry 450. The fourth terminal of the even duration determination circuitry 415 is coupled to the even duration 430 and the frequency comparator circuitry 445. The fifth terminal of the even duration determination circuitry 415 is coupled to the third input terminal of the frequency tracking circuitry 400, which supplies the line comparison signal. In some examples, the even duration determination circuitry 415 is instantiated by programmable circuitry executing even duration determination instructions to perform operations such as those represented by the flowchart(s) of FIGS. 5 and 6.

The odd duration determination circuitry 420 has a first terminal, a second terminal, a third terminal, a fourth terminal, and a fifth terminal. The first terminal of the odd duration determination circuitry 420 is coupled to the timer circuitry 405, the delay lock circuitry 410, the even duration determination circuitry 415, and the discharge window generator circuitry 450. The second terminal of the odd duration determination circuitry 420 is coupled to the delay lock circuitry 410, the even duration determination circuitry 415, the frequency comparator circuitry 445, the discharge window generator circuitry 450, and the third output terminal of the frequency tracking circuitry 400, which supplies the delay lock signal. The third terminal of the odd duration determination circuitry 420 is coupled to the odd duration 435, the frequency comparator circuitry 445, and the discharge window generator circuitry 450. The fourth terminal of the odd duration determination circuitry 420 is coupled to the odd duration 440 and the frequency comparator circuitry 445. The fifth terminal of the odd duration determination circuitry 420 is coupled to the third input terminal of the frequency tracking circuitry 400, which supplies the line comparison signal. In some examples, the odd duration determination circuitry 420 is instantiated by programmable circuitry executing odd duration determination instructions to perform operations such as those represented by the flowchart(s) of FIGS. 5 and 6.

The even duration 425 is coupled to the even duration determination circuitry 415, the frequency comparator circuitry 445, and the discharge window generator circuitry 450. In the example of FIG. 4, the even duration 425 stores a first determined duration representative of an approximation of a frequency of even cycles of the rectified signal from the diodes 308, 310. In some examples, the even duration 425 is implemented using memory circuitry, such as a register.

The even duration 430 is coupled to the even duration determination circuitry 415 and the frequency comparator circuitry 445. In the example of FIG. 4, the even duration 430 stores a second determined duration representative of an approximation of the frequency of even cycles of the rectified signal from the diodes 308, 310. In some examples, the even duration 430 is implemented using memory circuitry, such as a register.

The odd duration 435 is coupled to the odd duration determination circuitry 420, the frequency comparator circuitry 445, and the discharge window generator circuitry 450. In the example of FIG. 4, the odd duration 435 stores a third determined duration representative of an approximation of a frequency of odd cycles of the rectified signal from the diodes 308, 310. In some examples, the odd duration 435 is implemented using memory circuitry, such as a register.

The odd duration 440 is coupled to the odd duration determination circuitry 420 and the frequency comparator circuitry 445. In the example of FIG. 4, the odd duration 440 stores a fourth determined duration representative of an approximation of the frequency of odd cycles of the rectified signal from the diodes 308, 310. In some examples, the odd duration 440 is implemented using memory circuitry, such as a register.

The frequency comparator circuitry 445 has a first terminal, a second terminal, a third terminal, a fourth terminal, a fifth terminal, and a sixth terminal. The first terminal of the frequency comparator circuitry 445 is coupled to the delay lock circuitry 410, the even duration determination circuitry 415, the odd duration determination circuitry 420, the discharge window generator circuitry 450, and the third output terminal of the frequency tracking circuitry 400, which supplies the delay lock signal. The second terminal of the frequency comparator circuitry 445 is coupled to the even duration determination circuitry 415, the even duration 425, and the discharge window generator circuitry 450. The third terminal of the frequency comparator circuitry 445 is coupled to the even duration determination circuitry 415 and the even duration 430. The fourth terminal of the frequency comparator circuitry 445 is coupled to the odd duration determination circuitry 420, the odd duration 435, and the discharge window generator circuitry 450. The fifth terminal of the frequency comparator circuitry 445 is coupled to the odd duration determination circuitry 420 and the odd duration 440. The sixth terminal of the frequency comparator circuitry is 445 coupled to the discharge window generator circuitry 450 and the PAC window generator circuitry 460. In some examples, the frequency comparator circuitry 445 is instantiated by programmable circuitry executing frequency comparator instructions to perform operations such as those represented by the flowchart(s) of FIGS. 5 and 6.

The discharge window generator circuitry 450 has a first terminal, a second terminal, a third terminal, a fourth terminal, a fifth terminal, a sixth terminal, and a seventh terminal. The first terminal of the discharge window generator circuitry 450 is coupled to the timer circuitry 405, the delay lock circuitry 410, the even duration determination circuitry 415, and the odd duration determination circuitry 420. The second terminal of the discharge window generator circuitry 450 is coupled to the delay lock circuitry 410, the even duration determination circuitry 415, the odd duration determination circuitry 420, the frequency comparator circuitry 445, and the third output terminal of the frequency tracking circuitry 400, which supplies the delay lock signal. The third terminal of the discharge window generator circuitry 450 is coupled to the even duration determination circuitry 415, the even duration 425, and the frequency comparator circuitry 445. The fourth terminal of the discharge window generator circuitry 450 is coupled to the odd duration determination circuitry 420, the odd duration 435, and the frequency comparator circuitry 445. The fifth terminal of the discharge window generator circuitry 450 is coupled to the frequency comparator circuitry 445 and the PAC window generator circuitry 460. The sixth terminal of the discharge window generator circuitry 450 is coupled to the third input terminal of the frequency tracking circuitry 400, which supplies the line comparison signal. The seventh terminal of the discharge window generator circuitry 450 is coupled to the discharge timeout circuitry 455 and the first output terminal of the frequency tracking circuitry 400, which supplies the line detect enable signal. In some examples, the discharge window generator circuitry 450 is instantiated by programmable circuitry executing discharge window generator instructions to perform operations such as those represented by the flowchart(s) of FIGS. 5 and 6.

The discharge timeout circuitry 455 has a terminal coupled to the discharge window generator circuitry 450 and the first output terminal of the frequency tracking circuitry 400, which supplies the line detect enable signal. In some examples, the discharge timeout circuitry 455 is instantiated by programmable circuitry executing discharge timeout instructions to perform operations such as those represented by the flowchart(s) of FIGS. 5 and 6.

The PAC window generator circuitry 460 has a first terminal, a second terminal, a third terminal, and a fourth terminal. The first terminal of the PAC window generator circuitry 460 is coupled to the frequency comparator circuitry 445 and the discharge window generator circuitry 450. The second terminal of the PAC window generator circuitry 460 is coupled to the third input terminal of the frequency tracking circuitry 400, which supplies the line comparison signal. The third terminal of the PAC window generator circuitry 460 is coupled to the fourth input terminal of the frequency tracking circuitry 400, which supplies the comparison PAC signal. The fourth terminal of the PAC window generator circuitry 460 is coupled to the second output terminal of the frequency tracking circuitry 400, which supplies the PAC enable signal. In some examples, the PAC window generator circuitry 460 is instantiated by programmable circuitry executing PAC window generator instructions to perform operations such as those represented by the flowchart(s) of FIGS. 5 and 6.

FIG. 5 is a flowchart representative of example machine-readable instructions or example operations 500 that may be at least one of executed, instantiated, or performed using example implementations of the PAC converter circuitry 140, 200, 302 of FIGS. 1, 2, 3A, 3B, and 3C, the frequency lock circuitry 150, 304 of FIGS. 1, 3A, 3B, and 3C, or more generally the AC to DC converter circuitry 120, 300 of FIGS. 1, 3A, 3B, and 3C.

The example operations 500 of FIG. 5 begin at Block 505 at which the PAC converter circuitry 140, 200, 302 receives line and neutral supply signals. (Block 505). In some examples, the AC power supply 110 of FIG. 1 supplies a line signal and a neutral potential to the AC to DC converter circuitry 120, 300. The line signal is a sinusoidal alternating current signal having a fixed frequency. The neutral potential is a reference voltage representing a common potential. In some such examples, the AC power supply 110 is a grid connection, such as an outlet.

The diodes 205, 210, 308, 310 of FIGS. 2 and 3A generate a rectified signal using the line and neutral supply signals. (Block 510). In some examples, the diodes 205, 308 receive the line signal and the diodes 210, 310 receive the neutral potential. During a first portion of a cycle of the sinusoidal line signal, when the line signal has a voltage greater than the neutral potential, the diodes 205, 308 generate a first portion of a rectified signal by supplying current to the capacitors 215, 312 of FIGS. 2 and 3A. During a second portion of the cycle of the sinusoidal line signal, when the line signal has a voltage less than the neutral potential, the diodes 210, 310 generate a second portion of a rectified signal by supplying current to the capacitors 215, 312. In the examples described herein, the first portion of the rectified signal is referred to as an even cycle or an even portion of the rectified signal and the second portion of the rectified signal is referred to as an odd cycle or an odd portion of the rectified signal.

The frequency tracking circuitry 396, 400 of FIGS. 3A and 4 determines even and odd half cycle frequencies of the rectified signal. (Operations 600 of FIG. 6, below). In some examples, a DC bias of the line signal creates undesirable mismatches between zero crossings, which modify durations of the even and odd portions of the rectified signal. In such examples, the DC bias of the line signal increases the duration of time that the line signal is greater than the neutral potential (e.g., the even portion) and decreases the duration of time that the line signal is less than the neutral potential (e.g., the odd portion). For example, when biased by two volts, the duration between zero-crossings of the even portion of the rectified signal increase and the duration between zero-crossings of the odd portion of the rectified signal decrease. In example operation, the frequency tracking circuitry 396, 400 determines the durations of even and odd portions of the rectified signal using zero-crossings. In such example operations, the frequency lock circuitry 150, 304 of FIGS. 1, 3A, 3B, and 3C adjusts timing of the phase angle control of the current source circuitry 235, 322 of FIGS. 2 and 3B responsive to determining the duration of even and odd portions of the rectified signal. Advantageously, the frequency lock circuitry 150, 304 accounts for DC bias of the line signal by tracking the changes in even and odd portions.

The frequency tracking circuitry 396, 400 determines if the rectified signal is approaching an even or odd zero-crossing. (Block 515). In some examples, the frequency tracking circuitry 396, 400 uses a clock signal from the oscillator circuitry 382 of FIG. 3A and determined durations of the even and odd cycles of the rectified signal to predict subsequent zero-crossings. In example operations, the discharge window generator circuitry 450 predicts a zero-crossing to occur either one even or odd duration after a previous zero-crossing. For example, when the amplifier circuitry 376 of FIG. 3C sets the line comparison signal to represent a zero-crossing after an even portion of the rectified signal, the discharge window generator circuitry 450 determines a zero-crossing to occur after one odd duration. When the frequency tracking circuitry 396, 400 determines that the rectified signal is not approaching an even or odd zero-crossing (e.g., Block 515 returns a result of NO), control proceeds to return to Block 515. In such example operations, the discharge window generator circuitry 450 waits for the predicted zero-crossing timing to approach.

When the frequency tracking circuitry 396, 400 determines that the rectified signal is approaching an even or odd zero-crossing (e.g., Block 515 returns a result of YES), the current source circuitry 225, 318 of FIGS. 2 and 3B starts to sink a discharge current from the rectified signal. (Block 520). In some examples, the frequency tracking circuitry 396, 400 turns on the current source circuitry 225, 318 prior to the predicted zero-crossing. In such examples, the current source circuitry 225, 318 sinks current from one or more of the diodes 205, 210, 308, 310 or the capacitors 215, 312 to drive the rectified signal to the predicted zero-crossing. For example, the discharge window generator circuitry 450 turns on the current source circuitry 225, 318 five-hundred microseconds prior to a predicted zero-crossing. Advantageously, using the current source circuitry 225, 318 to drive the rectified signal to a zero-crossing before a predicted zero-crossing increases the accuracy of the PAC converter circuitry 140, 200, 302.

The amplifier circuitry 376 of FIG. 3C determines if the rectified signal is at a zero-crossing. (Block 525). In some examples, the transistor 314 and the diode 316 supply the rectified signal to the amplifier circuitry 376. In such examples, the amplifier circuitry 376 compares a voltage of the rectified signal to a low reference voltage, which represents a reference line voltage. In example operations, the low reference voltage of the amplifier circuitry 376 represents a zero-crossing voltage of the rectified signal. In such example operations, the low reference voltage accounts for DC offset of the line signal in relation to the neutral potential. Advantageously, the line comparison signal from the amplifier circuitry 376 represents zero-crossings as rising or falling edges.

If the amplifier circuitry 376 determines that the rectified signal is not at a zero-crossing (e.g., Block 525 returns a result of NO), the frequency tracking circuitry 396, 400 determines if a maximum window duration has occurred. (Block 530). In some examples, the discharge timeout circuitry 455 of FIG. 4 tracks a duration between the discharge window generator circuitry 450 turning on the current source circuitry 225, 318 and a present time. In such examples, the discharge timeout circuitry 455 stops tracking the duration responsive to the amplifier circuitry 376 detecting a zero-crossing. In example operation, the discharge timeout circuitry 455 determines a timeout condition is met responsive to the determined duration being greater than or equal to a reference timeout duration. The reference timeout duration represents a maximum duration that the current source circuitry 225, 318 may sink current from the rectified signal before a zero-crossing. Advantageously, the discharge timeout circuitry 455 turns off the current source circuitry 225, 318 after the reference timeout duration. Advantageously, the discharge timeout circuitry 455 prevents the current source circuitry 225, 318 from wasting power and failing to create a zero-crossing on the rectified signal. Control proceeds to return to the Operations 600.

If the amplifier circuitry 376 determines that the rectified signal is at a zero-crossing (e.g., Block 525 returns a result of YES), the current source circuitry 225, 318 stops sinking the discharge current from the rectified signal. (Block 535). In some examples, the frequency tracking circuitry 396, 400 turns off the current source circuitry 225, 318 responsive to the amplifier circuitry 376 detecting a zero-crossing. In example operation, the discharge window generator circuitry 450 turns off the current source circuitry 225, 318 responsive to the line comparison signal from the amplifier circuitry 376 representing a zero-crossing. In some such examples, the duration between turning on the current source circuitry 225, 318 and the zero-crossing that turns off the current source circuitry 225, 318 is referred to as a discharge window. During a discharge window, the current source circuitry 225, 318 drive the rectified signal to a zero-crossing responsive to sinking a current from the capacitors 215, 312. Advantageously, the frequency lock circuitry 150, 304 increases the power efficiency of the AC to DC converter circuitry 120, 300 by turning off the current source circuitry 225, 318 between discharge windows.

The current source circuitry 235, 322 of FIGS. 2 and 3B starts to supply a PAC current from the rectified signal to a capacitor. (Block 540). In some examples, the PAC window generator circuitry 460 turns on the current source circuitry 235, 322 responsive to the amplifier circuitry 376 detecting a zero-crossing. In such examples, the current source circuitry 235, 322 supplies current from one or more of the diodes 205, 210, 308, 310 or the capacitors 215, 312 to the capacitors 240, 324 of FIGS. 2 and 3A. In example operations, the capacitors 240, 324 generate the first supply voltage (VCC) by charging the capacitors 240, 324. In such example operations, the diodes 245, 326 of FIGS. 2 and 3A generate the second supply voltage (AVDD) to be approximately equal to the first supply voltage minus a voltage drop of the diodes 245, 326. Advantageously, the diodes 245, 326 prevent current from circuitry coupled to the second supply voltage from charging the capacitors 240, 324.

The amplifier circuitry 380 of FIG. 3C determines if a voltage of the capacitor is greater than a target voltage. (Block 545). In some examples, the capacitors 240, 324 generate the first supply voltage at the first output terminal of the AC to DC converter circuitry 120, 300 responsive to current from the current source circuitry 235, 322. In such examples, the amplifier circuitry 380 generates the comparison PAC signal responsive to comparing the first supply voltage to the reference voltage form the bandgap reference circuitry 378. If the amplifier circuitry 380 determines that the voltage of the capacitor is not greater than a target voltage (e.g., Block 545 returns a result of NO), control proceeds to return to Block 545.

If the amplifier circuitry 380 determines that the voltage of the capacitor is greater than a target voltage (e.g., Block 545 returns a result of YES), the current source circuitry 235, 322 stops supplying the PAC current. (Block 550). In some examples, the frequency tracking circuitry 396, 400 turns off the current source circuitry 235, 322 responsive to the amplifier circuitry 380 detecting the voltage across the capacitors 240, 324 is greater than or equal to the reference voltage. In example operation, the PAC window generator circuitry 460 turns off the current source circuitry 235, 322 responsive to the comparison PAC signal from the amplifier circuitry 380 representing the voltage across the capacitors 240, 324 is greater than or equal to the reference voltage. In some such examples, the duration between the zero-crossing that turns on the current source circuitry 235, 322 and turning off the current source circuitry 235, 322 is referred to as a PAC window. During a PAC window, the current source circuitry 235, 322 charges the capacitors 240, 324 using currents from the rectified signal. Control proceeds to return to Block 515.

Example methods are described with reference to the flowchart illustrated in FIG. 5. However, many other methods of implementing the PAC converter circuitry 140, 200, 302 of FIGS. 1, 2, 3A, 3B, and 3C, the frequency lock circuitry 150, 304 of FIGS. 1, 3A, 3B, and 3C, or more generally the AC to DC converter circuitry 120, 300 of FIGS. 1, 3A, 3B, and 3C may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

FIG. 6 is a flowchart representative of example machine-readable instructions or example operations 600 that may be at least one of executed, instantiated, or performed using an example implementation of the frequency tracking circuitry 396, 400 of FIGS. 3 and 4, or more generally the AC to DC converter circuitry 120, 300 of FIGS. 1 and 3. The example operations 600 of FIG. 6 begin at Block 610, at which the current source circuitry 225, 318 of FIGS. 2 and 3B starts to sink a discharge current from the rectified signal. (Block 610). In some examples, the frequency tracking circuitry 396, 400 generates a delay lock signal (D_DELAYED_LOCKED) responsive to one of a system enable signal (D_SYS_EN) transitioning to an on state or a determination that the frequencies of the rectified signal need to be determined. The delay lock signal represents when the frequency tracking circuitry 400 is determining even and odd durations of the rectified signal from the diodes 205, 210, 308, 310 of FIGS. 2 and 3A. In example operations, the discharge window generator circuitry 450 of FIG. 4 turns on the current source circuitry 225, 318 responsive to the delay lock signal. In such examples, the current source circuitry 225, 318 sinks current from one or more of the diodes 205, 210, 308, 310 or the capacitors 215, 312 of FIGS. 2 and 3A. Advantageously, determining timing of the even and odd portions of the rectified signal when the current source circuitry 225, 318 are conducting current increases the accuracy of the determined even and odd durations.

The even duration determination circuitry 415 of FIG. 4 determines a frequency of an even half cycle of the rectified signal. (Block 620). In some examples, the even duration determination circuitry 415 determines the even duration 425 of FIG. 4 to be the duration between zero-crossings of a first even portion of the rectified signal responsive to the delay lock signal. Also, the even duration determination circuitry 415 determines the even duration 430 of FIG. 4 to be the duration between zero-crossings of a subsequent even portion of the rectified signal. In example operation, the even duration determination circuitry 415 sets a value of the even duration 425 responsive to a difference of a count of the timer circuitry 405 of FIG. 4 at a first zero-crossing and at a second zero-crossing of the rectified signal. In such example operations, the even duration determination circuitry 415 sets a value of the even duration 425 responsive to a difference of the count of the timer circuitry 405 at a third zero-crossing and at a fourth zero-crossing of the rectified signal.

The odd duration determination circuitry 420 of FIG. 4 determines a frequency of an odd half cycle of the rectified signal. (Block 630). In some examples, the odd duration determination circuitry 420 determines the odd duration 435 of FIG. 4 to be the duration between zero-crossings of a first odd portion of the rectified signal responsive to the delay lock signal. Also, the odd duration determination circuitry 420 determines the odd duration 440 of FIG. 4 to be the duration between zero-crossings of a subsequent odd portion of the rectified signal. In example operation, the odd duration determination circuitry 420 sets a value of the odd duration 435 responsive to a difference of a count of the timer circuitry 405 at a second zero-crossing and at a third zero-crossing of the rectified signal. In such example operations, the odd duration determination circuitry 420 sets a value of the odd duration 435 responsive to a difference of the count of the timer circuitry 405 at a fourth zero-crossing and at a fifth zero-crossing of the rectified signal.

The frequency comparator circuitry 445 of FIG. 4 determines if two even and two odd half cycle frequencies have been determined. (Block 640). In some examples, the even duration determination circuitry 415 and the odd duration determination circuitry 415 set values of the even durations 425, 430 and the odd durations 435, 440 as zero-crossings of the rectified signal occur. In such examples, the frequency comparator circuitry 445 determines the even durations 425, 430 and the odd durations 435, 440 have been determined responsive to the even durations 425, 430 and the odd durations 435, 440 having set values. For example, the frequency comparator circuitry 445 determines that the even durations 425, 430 and the odd durations 435, 440 have been determined responsive to a comparison to default values. If the frequency comparator circuitry 445 determines that two even and two odd half cycle frequencies have not been determined (e.g., Block 640 returns a result of NO), control proceeds to return to Block 620.

If the frequency comparator circuitry 445 determines that two even and two odd half cycle frequencies have been determined (e.g., Block 640 returns a result of YES), the frequency comparator circuitry 445 determines if the two even and two odd half cycle frequencies have acceptable frequencies. (Block 650). In some examples, the frequency comparator circuitry 445 compares values of the even durations 425, 430 to determine an even frequency of even portions of the rectified signal. The frequency comparator circuitry 445 determines that the even durations 425, 430 represent an acceptable frequency responsive of a comparison of the determined even frequency to a range of acceptable frequencies (also referred to as a reference range of frequencies). For example, when an AC supply signal is expected to have a frequency of sixty hertz, the frequency comparator circuitry 445 has a range of acceptable frequencies inside of a range of plus or minus five percent of sixty hertz. Also, the frequency comparator circuitry 445 also compares values of the odd durations 435, 440 to determine an odd frequency of the determined odd portions of the rectified signal. In such examples, the frequency comparator circuitry 445 determines that the odd durations 435, 440 represent an acceptable frequency responsive of a comparison of the determined even frequency to the range of acceptable frequencies.

If the frequency comparator circuitry 445 determines that the two even and two odd half cycle frequencies do not have acceptable frequencies (e.g., Block 650 returns a result of NO), the current source circuitry 225, 318 stops sinking the discharge current. (Block 660). In some examples, the frequency tracking circuitry 396, 400 ends a delay lock window by changing the state of the delay lock signal. The delay lock window is a duration of time structured to include five zero-crossings of the rectified signal. In some example operations, the delay lock circuitry 410 generates the delay lock window having a fixed duration including at least five zero-crossings. In other examples, the delay lock circuitry 410 ends the delay lock window responsive to five zero-crossings of the rectified signal. In example operation, the discharge window generator circuitry 450 turns off the current source circuitry 225, 318 responsive to the delay lock circuitry 410 closing the delay lock window of the delay lock signal.

The delay lock circuitry 410 of FIG. 4 waits five-hundred milliseconds. (Block 670). In some examples, when the duration determination circuitry 415, 420 fails to determine values of the even durations 425, 430 or odd durations 435, 440 that represent acceptable frequencies, the frequency comparator circuitry 445 prevents the window generator circuitry 450, 460 of FIG. 4 from turning on the current source circuitry 225, 235, 318, 322 of FIGS. 2 and 3A. In such examples, the delay lock circuitry 410 generates a subsequent delay lock window after a delay duration. The delay duration allows the PAC converter circuitry 140, 200, 302 to stabilize before attempting to determine subsequent even and odd portions of the rectified signal. For example, the PAC converter circuitry 140, 200 waits five-hundred milliseconds between a determination that the durations 425, 430, 435, 440 do not represent acceptable frequencies and re-attempting to determine the durations 425, 430, 435, 440. Control proceeds to return to Block 610.

If the frequency comparator circuitry 445 determines that the two even and two odd half cycle frequencies have acceptable frequencies (e.g., Block 650 returns a result of YES), the current source circuitry 225, 318 stops sinking the discharge current. (Block 680). In some examples, the frequency tracking circuitry 396, 400 ends the delay lock window by changing the state of the delay lock signal. In example operations, the discharge window generator circuitry 450 turns off the current source circuitry 225, 318 responsive to the delay lock circuitry 410 closing the delay lock window of the delay lock signal. Control proceeds to return to Block 515 of FIG. 5.

Example methods are described with reference to the flowchart illustrated in FIG. 6. However, many other methods of implementing the frequency tracking circuitry 396, 400 of FIGS. 3 and 4, or more generally the AC to DC converter circuitry 120, 300 of FIGS. 1 and 3 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

FIG. 7 is a timing diagram 700 of example operations of the PAC converter circuitry 140, 200, 302 of FIGS. 1, 2, 3A, 3B, and 3C, the frequency lock circuitry 150, 304 of FIGS. 1, 3A, 3B, and 3C, or more generally the AC to DC converter circuitry 120, 300 of FIGS. 1, 3A, 3B, and 3C. In the example of FIG. 7, the timing diagram 700 illustrates an example line signal 705 (LINE), an example rectified signal 710 (RECT), an example line detect enable signal 715 (D_LINE_DET_EN), and an example PAC enable signal 720 (D_PAC_EN).

The line signal 705 represents the supply of power from the AC power supply 110 of FIG. 1. In some examples, the line signal 705 is a sinusoidal signal having a frequency. In some such examples, such as when the AC power supply 110 represents a connection to the grid, the frequency of the line signal 705 depends on the geographical location of the connection.

The rectified signal 710 represents a signal supplied by the diodes 205, 210, 308, 310 of FIGS. 2 and 3A to the capacitors 215, 312 of FIGS. 2 and 3A. In example operations, the diodes 205, 210, 308, 310 generate the rectified signal 710 responsive to rectifying the line signal 705.

The line detect enable signal 715 represents a control of the current source circuitry 225, 318 of FIGS. 2 and 3B. When set to a logic high, the line detect enable signal 715 turns on the current source circuitry 225, 318. When set to a logic low, the line detect enable signal 715 turns off the current source circuitry 225, 318. In some examples, such as in FIG. 4, the discharge window generator circuitry 450 of FIG. 4 generates the line detect enable signal 715.

The PAC enable signal 720 represents a control of the current source circuitry 235, 322 of FIGS. 2 and 3B. When set to a logic high, the PAC enable signal 720 turns on the current source circuitry 235, 322. When set to a logic low, the PAC enable signal 720 turns off the current source circuitry 235, 322. In some examples, such as in FIG. 4, the PAC window generator circuitry 460 of FIG. 4 generates the PAC enable signal 720. In other examples, the logic device 392 of FIG. 3C generates the PAC enable signal 720.

At a first time 725, the AC power supply 110 supplies the line signal 705 and the diodes 205, 308 begin generating a first odd portion (T_ODD1) of the rectified signal 710. Also at the first time 725, the discharge window generator circuitry 450 sets the line detect enable signal 715 to turn on the current source circuitry 225, 318 responsive to the delay lock circuitry 410 beginning a delay lock window. During the delay lock window, the line detect enable signal 715 is set and the frequency tracking circuitry 396, 400 determines the frequency of even and odd portions of the line signal.

At a second time 730, the amplifier circuitry 376 of FIG. 3C detects a zero-crossing of the line signal 705 and the diodes 210, 310 begin generating a first even portion (T_EVEN1) of the rectified signal 710. Also at the second time 730, the odd duration determination circuitry 420 of FIG. 4 sets the value of the first odd duration 435 of FIG. 4 based on the duration between the times 725, 730.

At a third time 735, the amplifier circuitry 376 detects another zero-crossing of the line signal 705 and the diodes 205, 308 begin generating a second odd portion (T_ODD2) of the rectified signal 710. Also at the third time 735, the even duration determination circuitry 415 of FIG. 4 sets the value of the first even duration 425 of FIG. 4 based on the duration between the times 730, 735.

At a fourth time 740, the amplifier circuitry 376 detects yet another zero-crossing of the line signal 705 and the diodes 210, 310 begin generating a second even portion (T_EVEN2) of the rectified signal 710. Also at the fourth time 740, the odd duration determination circuitry 420 sets the value of the second odd duration 440 of FIG. 4 based on the duration between the times 735, 740.

At a fifth time 745, the amplifier circuitry 376 detects another zero-crossing of the line signal 705 and the even duration determination circuitry 415 sets the value of the second even duration 430 of FIG. 4 based on the duration between the times 740, 745. Also at the fifth time 745, the discharge window generator circuitry 450 clears the line detect enable signal 715 to turn off (e.g., disable) the current source circuitry 225, 318 responsive to the delay lock circuitry 410 ending the delay lock window. In the example of FIG. 7, the delay lock circuitry 410 is structured to generate a delay lock window having a duration equal to the duration between times 725, 745. In some such examples, the duration of the delay lock window is set responsive to a detection of five zero-crossings of the line signal 705. At the fifth time 745, the frequency comparator circuitry 445 of FIG. 4 compares the even durations 425, 430 and the odd durations 435, 440. The frequency comparator circuitry 445 determines that the even durations 425, 430 and the odd durations 435, 440 accurately represent even and odd portions of the rectified signal 710 responsive to the even durations 425, 430 being approximately, preferably exactly, equal and the odd durations 435, 440 being approximately, preferably exactly, equal.

After the frequency comparator circuitry 445 determines that the frequency tracking circuitry 396, 400 have determined timing of even and odd portions of the rectified signal 710, the discharge window generator circuitry 450 sets the line detect enable signal 715 at a sixth time 750. In the example of FIG. 7 and prior to the sixth time 750, the discharge window generator circuitry 450 predicts a zero-crossing of the rectified signal at a seventh time 755 responsive to the zero-crossing at the fifth time 745 and the odd duration 435. In such examples, the current source circuitry 225, 318 drive the rectified signal 710 to a zero-crossing at the seventh time 755 responsive to the discharge window generator circuitry 450 setting the line detect enable signal 715 at the sixth time 750. At the seventh time 755, the discharge window generator circuitry 450 completes a discharge window by clearing the line detect enable signal 715, which turns off the current source circuitry 225, 318. Advantageously, turning on the current source circuitry 225, 318 at the sixth time 755 increases a likelihood of the rectified signal 710 having a zero-crossing at the seventh time 755. Advantageously, turning on the current source circuitry 225, 318 prior to a predicted zero-crossing synchronizes the operations of the frequency tracking circuitry 396, 400 to the rectified signal 710.

At the seventh time 755, the PAC window generator circuitry 460 sets the PAC enable signal 720 responsive to the amplifier circuitry 376 detecting a zero-crossing of the rectified signal 710. The PAC enable signal 720 turns on the current source circuitry 235, 322 at the seventh time 755, which charges the capacitors 240, 324 of FIGS. 2 and 3A.

At an eighth time 760, the PAC window generator circuitry 460 clears the PAC enable signal 720 responsive to the amplifier circuitry 380 of FIG. 3C detecting the first supply voltage of the capacitors 240, 324 is greater than the reference voltage from the bandgap reference circuitry 378 of FIG. 3. In some examples, the PAC window generator circuitry 460 clears the PAC enable signal 720 at the eighth time 760 responsive to a determination that the rectified signal 710 is approaching an unsafe operating voltage (e.g., a voltage greater than a maximum voltage of the PAC converter circuitry 140, 200, 302. In some such examples, the PAC window generator circuitry 460 determines the rectified signal 710 is approaching an unsafe operating voltage responsive to a duration between the times 755, 760. Such a duration may be referred to as a maximum PAC window duration. At the eighth time 760, the current source circuitry 235, 322 stop charging the capacitors 240, 324 responsive to the PAC window generator circuitry 460 clearing the PAC enable signal 720. Advantageously, the frequency lock circuitry 150, 304 turns on the current source circuitry 235, 322 responsive to the rectified signal being at voltages between a common potential and a maximum safe operating voltage.

After the zero-crossing at the seventh time 755, the discharge window generator circuitry 450 sets the line detect enable signal 715 at a ninth time 765. In the example of FIG. 7 and prior to the ninth time 765, the discharge window generator circuitry 450 predicts a zero-crossing of the rectified signal at a tenth time 770 responsive to the zero-crossing at the seventh time 755 and the even duration 425. In such examples, the current source circuitry 225, 318 drive the rectified signal 710 to a zero-crossing at the tenth time 770 responsive to the discharge window generator circuitry 450 setting the line detect enable signal 715 at the ninth time 765. At the tenth time 770, the discharge window generator circuitry 450 completes a discharge window by clearing the line detect enable signal 715, which turns off the current source circuitry 225, 318. At the tenth time 770, the PAC window generator circuitry 460 sets the PAC enable signal 720 responsive to the amplifier circuitry 376 detecting a zero-crossing of the rectified signal 710. The PAC enable signal 720 turns on the current source circuitry 235, 322 at the tenth time 770, which charges the capacitors 240, 324.

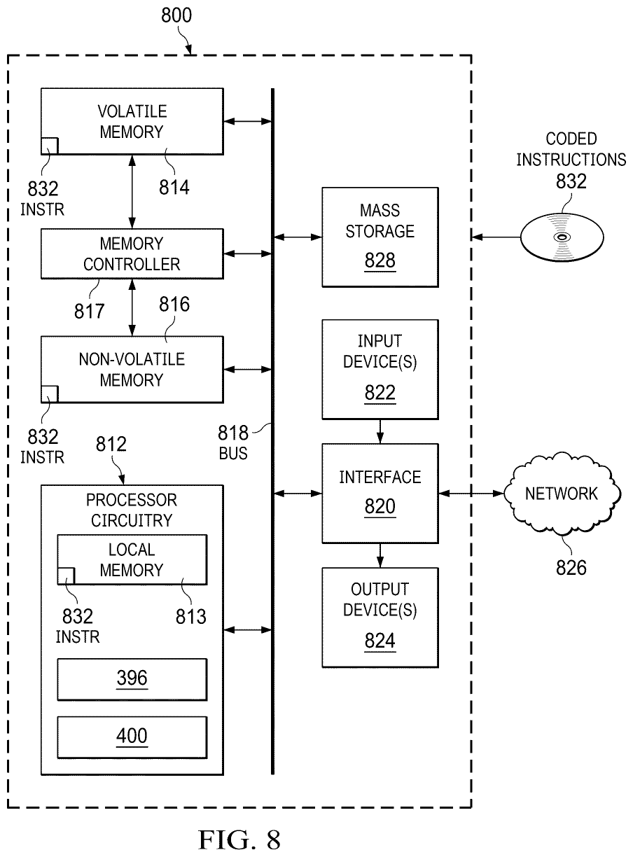

FIG. 8 is a block diagram of an example programmable circuitry platform 800 structured to one or a combination of execute or instantiate one or more of the example machine-readable instructions or the example operations of FIGS. 5 and 6 to implement the frequency tracking circuitry 396, 400 of FIGS. 3A and 4. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, or microcontrollers from any desired family or manufacturer. The programmable circuitry 812 may be implemented by one or more semiconductor based (e.g., silicon based) devices. In this example, the programmable circuitry 812 implements the timer circuitry 405, the delay lock circuitry 410, the even duration determination circuitry 415, the odd duration determination circuitry 420, the first even duration 425, the second even duration 430, the first odd duration 435, the second odd duration 440, the frequency comparator circuitry 445, the discharge window generator circuitry 450, the discharge timeout circuitry 455, and the PAC window generator circuitry 460 of FIG. 4.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 816 may be implemented by one or a combination of flash memory or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter one of or a combination of data or commands into the programmable circuitry 812. The input device(s) 822 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 824 are also connected to the interface circuitry 820 of the illustrated example. The output device(s) 824 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 820 of the illustrated example, thus, includes one of or a combination of a graphics driver card, a graphics driver chip, or graphics processor circuitry such as a GPU.

The interface circuitry 820 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store one or more of firmware, software, or data. Examples of such mass storage discs or devices 828 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 832, which may be implemented by the machine-readable instructions of FIGS. 5 and 6, may be stored in one of or a combination of the mass storage device 828, in the volatile memory 814, in the non-volatile memory 816, or on at least one non-transitory computer readable storage medium such as a CD or DVD which may be removable.

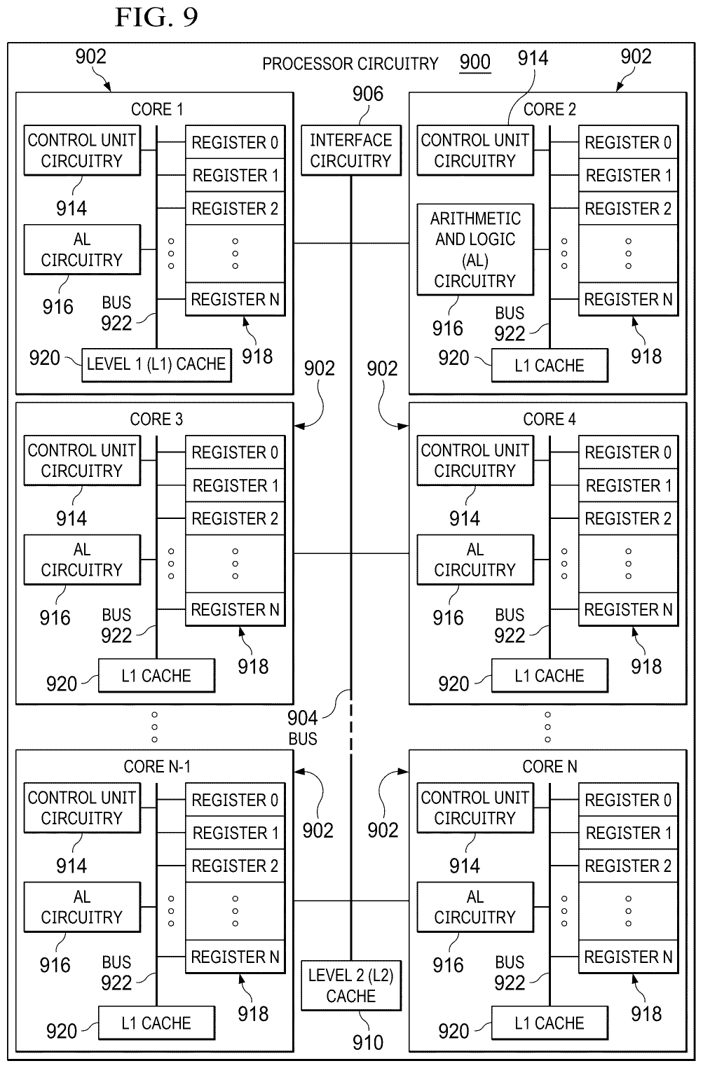

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 5 and 6 to effectively instantiate the circuitry of FIG. 2 as logic circuits to perform operations corresponding to those machine-readable instructions. In some such examples, the frequency tracking circuitry 396, 400 of FIGS. 3A and 4 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine-readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine-readable instructions or operations represented by the flowcharts of FIGS. 5 and 6.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Also or alternatively, the first bus 904 may be implemented by any other type of computing or electrical bus. The cores 902 may obtain data, instructions, and signals from one or more external devices by example interface circuitry 906. The cores 902 may output data, instructions, and signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and instructions. Data and instructions may be transferred (e.g., shared) by one of or a combination of writing to or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic or logic operations on the data within the corresponding core 902. The AL circuitry 916 of some examples performs integer-based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 or, more generally, the microprocessor 900 may include additional or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) or other circuitry may be present. The microprocessor 900 is a semiconductor device fabricated to include many transistors interconnected to implement the structures described above in one or more integrated circuits (ICs) contained in one or more packages.

The microprocessor 900 may include or cooperate with one or more accelerators (e.g., acceleration circuitry, hardware accelerators, etc.). In some examples, accelerators are implemented by logic circuitry to perform certain tasks more quickly and efficiently than can be done by a general-purpose processor. Examples of accelerators include ASICs and FPGAs such as those discussed herein. A GPU, DSP, or other programmable device can also be an accelerator. Accelerators may be on-board the microprocessor 900, in the same chip package as the microprocessor 900, or in one or more separate packages from the microprocessor 900.

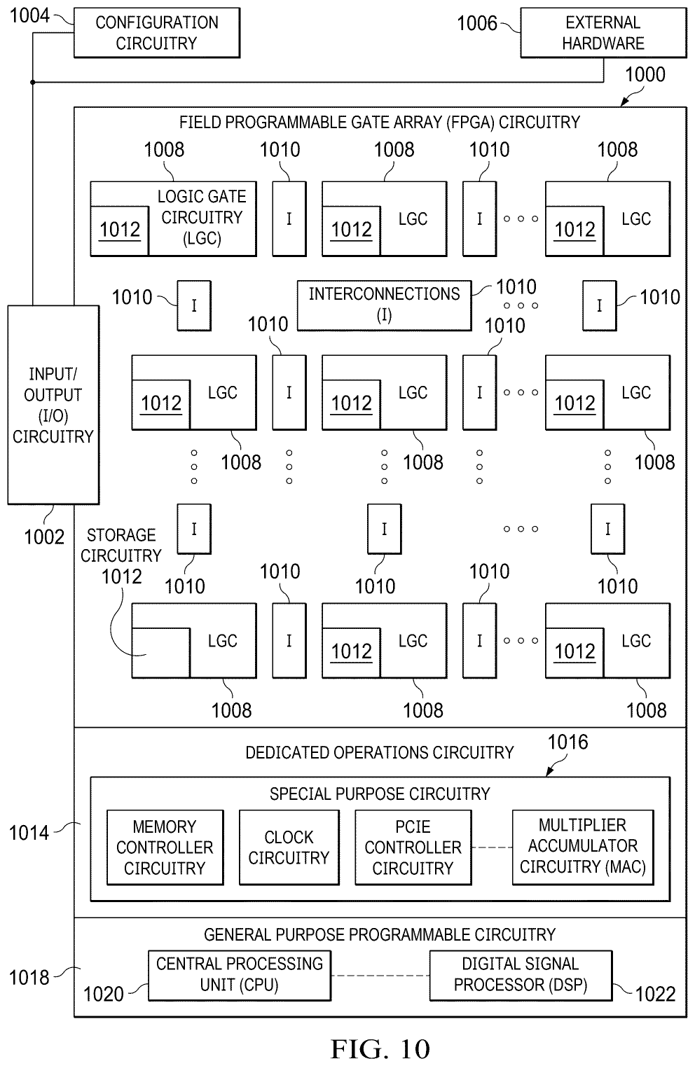

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine-readable instructions. However, once configured, the FPGA circuitry 1000 instantiates the operations and functions corresponding to the machine-readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine-readable instructions represented by the flowchart(s) of FIGS. 5 and 6 but whose interconnections and logic circuitry are fixed once fabricated), the FPGA circuitry 1000 of the example of FIG. 10 includes interconnections and logic circuitry that may be one of or a combination of configured, structured, programmed, and interconnected in different ways after fabrication to instantiate, for example, some or all of the operations/functions corresponding to the machine-readable instructions represented by the flowchart(s) of FIGS. 5 and 6. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5 and 6. As such, the FPGA circuitry 1000 may be at least one of configured or structured to effectively instantiate some or all of the operations/functions corresponding to the machine-readable instructions of the flowchart(s) of FIGS. 5 and 6 as dedicated logic circuits to perform the operations/functions corresponding to those software instructions in a dedicated manner analogous to an ASIC. Therefore, the FPGA circuitry 1000 may perform the operations/functions corresponding to the some or all of the machine-readable instructions of FIGS. 5 and 6 faster than the general-purpose microprocessor can execute the same.

In the example of FIG. 10, the FPGA circuitry 1000 is at least one of configured or structured in response to being programmed (and/or reprogrammed one or more times) based on a binary file. In some examples, the binary file may be one of or both of compiled or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may at least one of access or load the binary file to cause the FPGA circuitry 1000 of FIG. 10 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1000 of FIG. 10 to at least one of configure or structure the FPGA circuitry 1000 of FIG. 10, or portion(s) thereof.

In some examples, the binary file is at least one of compiled, generated, transformed, or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is at least one of compiled, generated, or otherwise output from the uniform software platform based on the second instructions. In some examples, the FPGA circuitry 1000 of FIG. 10 may at least one of access or load the binary file to cause the FPGA circuitry 1000 of FIG. 10 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1000 of FIG. 10 to at least one of configure or structure the FPGA circuitry 1000 of FIG. 10, or portion(s) thereof.

The FPGA circuitry 1000 of FIG. 10, includes example input/output (I/O) circuitry 1002 to at least one of obtain or output data to/from at least one of example configuration circuitry 1004 or external hardware 1006. For example, the configuration circuitry 1004 may be implemented by interface circuitry that may obtain a binary file, which may be implemented by one or more of a bit stream, data, or machine-readable instructions, to configure the FPGA circuitry 1000, or portion(s) thereof. In some such examples, the configuration circuitry 1004 may obtain the binary file from one of or a combination of a user, a machine (e.g., hardware circuitry (e.g., programmable or dedicated circuitry) that may implement an Artificial Intelligence/Machine Learning (AI/ML) model to generate the binary file, etc.), or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine-readable instructions of FIGS. 5 and 6 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of one of or a combination of the electrical structures or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 or an example DSP 1022. Other general purpose programmable circuitry 1018 may also or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may also be implemented by combining at least the example microprocessor 900 of FIG. 9 and the example FPGA circuitry 1000 of FIG. 10. In some such hybrid examples, one or more cores 902 of FIG. 9 may execute a first portion of the machine-readable instructions represented by the flowchart(s) of FIGS. 5 and 6 to perform first operation(s)/function(s), the FPGA circuitry 1000 of FIG. 10 may be at least one of configured or structured to perform second operation(s)/function(s) corresponding to a second portion of the machine-readable instructions represented by the flowcharts of FIGS. 5 and 6, and/or an ASIC may be at least one of configured or structured to perform third operation(s)/function(s) corresponding to a third portion of the machine-readable instructions represented by the flowcharts of FIGS. 5 and 6.

Some or all of the frequency tracking circuitry 396, 400 of FIGS. 3A and 4 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be at least one of configured or structured to perform operations/functions corresponding to portion(s) of machine-readable instructions at the same and/or different times.

In some examples, some or all of the frequency tracking circuitry 396, 400 of FIGS. 3A and 4 may be instantiated, for example, in one or more threads executing concurrently and/or in series. For example, the microprocessor 900 of FIG. 9 may execute machine-readable instructions in one or more threads executing concurrently and/or in series. In some examples, the FPGA circuitry 1000 of FIG. 10 may be at least one of configured or structured to carry out operations/functions concurrently and/or in series. Moreover, in some examples, some or all of the frequency tracking circuitry 396, 400 of FIGS. 3A and 4 may be implemented within one or more virtual machines or containers executing on the microprocessor 900 of FIG. 9.

In some examples, the programmable circuitry 812 of FIG. 8 may be in one or more packages. For example, at least one of the microprocessor 900 of FIG. 9 or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

While an example manner of implementing the frequency tracking circuitry 396 of FIG. 3A is illustrated in FIG. 4, one or more of the elements, processes, or devices illustrated in FIG. 4 may be combined, divided, re-arranged, omitted, eliminated, or implemented in any other way. Further, the timer circuitry 405, the delay lock circuitry 410, the even duration determination circuitry 415, the odd duration determination circuitry 420, the first even duration 425, the second even duration 430, the first odd duration 435, the second odd duration 440, the frequency comparator circuitry 445, the discharge window generator circuitry 450, the discharge timeout circuitry 455, and the PAC window generator circuitry 460 of FIG. 4, or, more generally, the example frequency tracking circuitry 396, 400 of FIGS. 3A and 4, may be implemented by hardware alone or by hardware in combination with software and firmware. Thus, for example, any of the timer circuitry 405, the delay lock circuitry 410, the even duration determination circuitry 415, the odd duration determination circuitry 420, the first even duration 425, the second even duration 430, the first odd duration 435, the second odd duration 440, the frequency comparator circuitry 445, the discharge window generator circuitry 450, the discharge timeout circuitry 455, and the PAC window generator circuitry 460 of FIG. 4, or, more generally, the example frequency tracking circuitry 400 of FIG. 4, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example frequency tracking circuitry 396, 400 of FIGS. 3A and 4 may include one or more elements, processes, or devices in addition to, or instead of, those illustrated in FIG. 4, or may include more than one of any or all of the illustrated elements, processes and devices.

Flowchart(s) representative of example machine-readable instructions, which may be executed by programmable circuitry to at least one of implement or instantiate the frequency tracking circuitry 396, 400 of FIGS. 3A and 4 or representative of example operations which may be performed by programmable circuitry to at least one of implement or instantiate the frequency tracking circuitry 396, 400 of FIGS. 3A and 4, are shown in FIGS. 5 and 6. The machine-readable instructions may be one or more executable programs or portion(s) of one or more executable programs for execution by programmable circuitry such as the programmable circuitry 812 shown in the example processor platform 800 discussed below in connection with FIG. 8 and may be one or more function(s) or portion(s) of functions to be performed by the example programmable circuitry (e.g., an FPGA) discussed below in connection with FIG. 9 or 10. In some examples, the machine-readable instructions cause an operation, a task, etc., to be carried out or performed in an automated manner in the real-world. As used herein, “automated” means without human involvement.

The program may be embodied in instructions (e.g., software and/or firmware) stored on one or more non-transitory computer readable and/or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable and/or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5 and 6, many other methods of implementing the example frequency tracking circuitry 396, 400 of FIGS. 3A and 4 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5 and 6 may be implemented using executable instructions (e.g., computer readable and/or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function /r other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means +/−10 percent of the stated value, or, if the value is zero, a reasonable range of values around zero.

Modifications are possible in the described embodiments, and other embodiments are possible, within the scope of the claims.

What is claimed is:

1. An apparatus comprising:
an alternating current (AC) supply terminal;
first current source circuitry having a first terminal, a second terminal, and a control terminal;
second current source circuitry having a first terminal and a control terminal, the first terminal of the second current source circuitry coupled to the AC supply terminal and the first terminal of the first current source circuitry;
a capacitor having a terminal;
comparator circuitry having an input terminal and an output terminal, the input terminal of the comparator circuitry coupled to the terminal of the capacitor and the second terminal of the first current source circuitry; and
timer circuitry having an input terminal, a first output terminal, and a second output terminal, the input terminal of the timer circuitry coupled to the output terminal of the comparator circuitry, the first output terminal of the timer circuitry coupled to the control terminal of the first current source circuitry, the second output terminal of the timer circuitry coupled to the control terminal of the second current source circuitry.

2. The apparatus of claim 1, further comprising:
a line terminal;
a supply terminal;
a first diode having a first terminal and a second terminal, the first terminal of the first diode is coupled to the line terminal;
a second diode having a first terminal and a second terminal, the first terminal of the second diode is coupled to the supply terminal; and
a transistor having a first terminal and a second terminal, the first terminal of the transistor is coupled to the second terminal of the first diode and the second terminal of the second diode, the second terminal of the transistor is coupled to the AC supply terminal, the first terminal of the first current source circuitry, and the first terminal of the second current source circuitry.

3. The apparatus of claim 1, further comprising:
a transistor having a first terminal and a control terminal, the first terminal of the transistor is coupled to the AC supply terminal, the first terminal of the first current source circuitry, the first terminal of the second current source circuitry;
a switch having a first terminal, a second terminal, and a control terminal, the first terminal of the switch is coupled to the terminal of the capacitor and the second terminal of the second current source circuitry, the second terminal of the switch is coupled to the control terminal of the transistor; and
an inverter having an input terminal and an output terminal, the input terminal of the inverter is coupled to the control terminal of the first current source circuitry and the first output terminal of the timer circuitry, the output terminal of the inverter is coupled to the control terminal of the switch.

4. The apparatus of claim 1, wherein the comparator circuitry is first comparator circuitry, the input terminal of the timer circuitry is a first input terminal, the timer circuitry further has a second input terminal, and the apparatus further comprising second comparator circuitry having an input terminal and an output terminal, the input terminal of the second comparator circuitry is coupled to the AC supply terminal, the first terminal of the first current source circuitry, and the first terminal of the second current source circuitry, the output terminal of the second comparator circuitry is coupled to the second input terminal of the timer circuitry.

5. The apparatus of claim 1, wherein the timer circuitry is configured to:
determine a first duration of even portions of an AC signal at the AC supply terminal;
determine a second duration of odd portions of the AC signal at the AC supply terminal; and
determine a timing of a zero-crossing of the AC signal at the AC supply terminal based on the first duration and the second duration.

6. The apparatus of claim 5, wherein the timer circuitry is configured to:
turn on the first current source circuitry prior to the timing of the zero-crossing at the AC supply terminal;
turn off the first current source circuitry responsive to the zero-crossing at the AC supply terminal; and
turn on the second current source circuitry responsive to turning off the first current source circuitry.

7. An apparatus comprising:
a supply terminal configured to receive a rectified signal;
first current source circuitry coupled to the supply terminal, the first current source circuitry configured to discharge the supply terminal responsive to a first voltage;
second current source circuitry coupled to the supply terminal and the first current source circuitry, the second current source circuitry configured to supply a current from the supply terminal responsive to a second voltage;
a capacitor coupled to the second current source circuitry, the capacitor configured to generate a direct current (DC) supply voltage responsive to current from the second current source circuitry; and
frequency lock circuitry coupled to the supply terminal, the first current source circuitry, and the second current source circuitry. the frequency lock circuitry configured to:
predict a zero-crossing of the rectified signal;
generate the first voltage before the predicted zero-crossing; and
detect a zero-crossing of the rectified signal after generating the first voltage; and
generate the second voltage after detecting the zero-crossing.

8. The apparatus of claim 7, further comprising rectifier circuitry coupled to the supply terminal, the rectifier circuitry configured to generate the rectified signal based on an AC signal and a common potential.

9. The apparatus of claim 7, wherein the frequency lock circuitry includes:
first comparator circuitry coupled to the supply terminal, the first comparator circuitry is configured to detect the zero-crossing of the rectified signal; and
second comparator circuitry coupled to the second current source circuitry and the capacitor, the second comparator circuitry is configured to detect the DC supply voltage is less than a reference voltage.

10. The apparatus of claim 9, wherein the frequency lock circuitry further includes timer circuitry coupled to the first comparator circuitry and the second comparator circuitry, the timer circuitry configured to:
turn on the first current source circuitry responsive to a predicted zero-crossing occurring after a reference timeout duration by generating the first voltage;
turn off the first current source circuitry after the first comparator circuitry detecting the zero-crossing of the rectified signal; and
turn on the second current source circuitry by generating the second voltage after the first comparator circuitry detecting the zero-crossing of the rectified signal.

11. The apparatus of claim 9, wherein the frequency lock circuitry further includes:
oscillator circuitry configured to generate a clock signal; and
timer circuitry coupled to the first comparator circuitry and the oscillator circuitry, the timer circuitry configured to:
determine a first duration between a first zero-crossing and a second zero-crossing of the rectified signal using the clock signal;
determine a second duration between the second zero-crossing and a third zero-crossing of the rectified signal using the clock signal;
determine a first signal to have a first frequency based on the first duration;
determine a second signal to have a second frequency based on the second duration; and
predict a subsequent zero-crossing of the rectified signal based on a subsequent zero-crossing and one of the first duration or the second duration.

12. The apparatus of claim 7, wherein the frequency lock circuitry is further configured to:
disable the first current source circuitry and the second current source circuitry for a third duration;
during the third duration, determine a first value representing a frequency of even portions of the rectified signal;
during the second duration, determine a second value representing a frequency of the even portions of the rectified signal;
compare the first value and the second value to determine the frequency of the even portions of the rectified signal; and
predict zero-crossings of the even portions of the rectified signal using the first value and the second value.

13. The apparatus of claim 7, wherein the frequency lock circuitry is further configured to:
disable the first current source circuitry and the second current source circuitry for a first duration;
during the first duration, determine a first value representing a frequency of even portions of the rectified signal;
during the first duration, determine a second value representing a frequency of the even portions of the rectified signal;
compare the first value and the second value to determine the frequency of the even portions of the rectified signal; and
disable the first current source circuitry and the second current source circuitry for a second duration responsive to a determination that the first value and the second value are different.

14. A power supply comprising:
a supply terminal configured to receive a rectified signal;
first current source circuitry coupled to the supply terminal, the first current source circuitry configured to discharge the supply terminal;
second current source circuitry coupled to the supply terminal and the first current source circuitry, the second current source circuitry configured to supply a current from the supply terminal;
a capacitor coupled to the second current source circuitry, the capacitor configured to generate a direct current (DC) supply voltage responsive to current from the second current source circuitry; and
comparator circuitry coupled to the supply terminal, the comparator circuitry configured to determine zero-crossings of the rectified signal; and
timer circuitry coupled to the first current source circuitry, the second current source circuitry, and the comparator circuitry, the timer circuitry configured to:
determine a first duration between a first zero-crossing and a second zero-crossing of the rectified signal;
determine a second duration between the second zero-crossing and a third zero-crossing of the rectified signal;
predict subsequent zero-crossings of the rectified signal based on the first duration and the second duration; and
control the first current source circuitry and the second current source circuitry based on the subsequent zero-crossings.

15. The power supply of claim 14, further comprising:
a grid connection including:
a line terminal configured to supply an AC signal; and
a neutral terminal configured to supply a common potential; and
rectifier circuitry coupled to the grid connection and the supply terminal, the rectifier circuitry configured to generate the rectified signal based on the AC signal and the common potential.

16. The power supply of claim 14, wherein the timer circuitry is further configured to:
determine a third duration between the third zero-crossing and a fourth zero-crossing of the rectified signal;
determine a fourth duration between the fourth zero-crossing and a fifth zero-crossing of the rectified signal;
compare the first duration and the third duration; and
compare the second duration and the fourth duration.

17. The power supply of claim 16, wherein the timer circuitry is further configured to:
when a difference between the first duration and the third duration is outside a reference range, determine a first frequency of even cycles of the rectified signal; and
when the difference between the first duration and the third duration is inside the reference range, determine the first duration and the third duration after a delay duration.

18. The power supply of claim 14, wherein the timer circuitry is further configured to:
predict a fourth zero-crossing to occur the first duration after the third zero-crossing;
turn on the first current source circuitry before the fourth zero-crossing; and
turn off the second current source circuitry after the comparator circuitry detects the fourth zero-crossing.

19. The power supply of claim 14, wherein the timer circuitry is further configured to:
predict a fourth zero-crossing to occur the first duration after the third zero-crossing;
turn on the first current source circuitry before the fourth zero-crossing; and
turn off the first current source circuitry after the comparator circuitry fails to detect the fourth zero-crossing within a reference timeout duration.

20. The power supply of claim 19, further comprising a diode coupled to the second current source circuitry, the capacitor, the comparator circuitry, and the timer circuitry, the diode configured to generate a supply voltage by decreasing the DC supply voltage by a voltage drop across the diode.
